(19) United States
(12) Patent Application Publication
(10) Pub. No.: US 2026/0352387 A1
(43) Pub. Date: Nov. 5, 2026

(54) AMBIENT IOT FREQUENCY HOPPING

(71) Applicant: QUALCOMM Incorporated, San Diego, CA (US)

(72) Inventors: Zhikun WU, Beijing (CN); Yuchul KIM, San Diego, CA (US); Huilin XU, Beijing (CN); Wanshi CHEN, San Diego, CA (US); Ahmed ELSHAFIE, San Diego, CA (US); Peter GAAL, San Diego, CA (US); Umesh PHUYAL, San Diego, CA (US)

(21) Appl. No.: 19/488,050

(22) PCT Filed: Jul. 26, 2023
(86) PCT No.: PCT/CN2023/109270

§ 371 Date: Nov. 25, 2025

(51) Int. Cl. H04L 5/00

(52) U.S. Cl. CPC H04L 5/0012; H04L 5/0094

(57) ABSTRACT

This disclosure presents enhanced wireless communication in an A-IoT system using frequency hopping mechanisms for FL data, FL CW, and BL data. Various configurations for frequency hopping patterns and trigger events are provided. The relationship between FL data subchannels, FL CW subchannels, and BL data subchannels offers flexibility and efficiency in communication between the RF source, ambient IoT devices, and RF readers. The RF source sends FL data and FL CW with frequency hopping patterns and configures ambient IoT devices to send BL data with frequency hopping patterns. The RF reader obtains BL data from the ambient IoT device, with the BL data configured to frequency hop according to a BL frequency hopping pattern or the FL CW frequency hopping pattern. The ambient IoT device obtains the FL CW modulated with FL data and sends BL data in response, with the BL data configured to frequency hop.

### TECHNICAL FIELD

The present disclosure generally relates to wireless communication, and more particularly, to a wireless communication system providing enhanced communication efficiency and reliability in an Ambient Internet of Things (A-IoT) system through the implementation of frequency hopping mechanisms for forward link (FL) data, forward link continuous wave (FL CW), and backward link (BL) data transmissions.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

One innovative aspect of the subject matter described in this disclosure may be implemented in a method for wireless communication performable at a radio frequency (RF) source. The method includes sending a forward link (FL) continuous wave (CW) modulated with FL data, the FL CW configured to frequency hop according to a FL data frequency hopping pattern or a FL CW frequency hopping pattern; and configuring an ambient Internet of Things (IoT) device to send backward link (BL) data in response to the FL data using the FL CW, the BL data configured to frequency hop according to a BL frequency hopping pattern or the FL CW frequency hopping pattern.

Another innovative aspect of the subject matter described in this disclosure may be implemented in an apparatus for wireless communication, such as an RF source. The apparatus includes one or more memories, and one or more processors each communicatively coupled with at least one of the one or more memories. The one or more processors, individually or in any combination, are operable to cause the apparatus to send a FL CW modulated with FL data, the FL CW configured to frequency hop according to a FL data frequency hopping pattern or a FL CW frequency hopping pattern; and configure an ambient IoT device to send BL data in response to the FL data using the FL CW, the BL data configured to frequency hop according to a BL frequency hopping pattern or the FL CW frequency hopping pattern.

Another innovative aspect of the subject matter described in this disclosure may be implemented in an apparatus for wireless communication, such as an RF reader. The apparatus includes one or more memories, and one or more processors each communicatively coupled with at least one of the one or more memories. The one or more processors, individually or in any combination, are operable to cause the apparatus to obtain BL data from an ambient IoT device, the BL data configured to frequency hop according to a BL frequency hopping pattern or a FL CW frequency hopping pattern. The BL data is responsive to an FL CW modulated with FL data from a RF source, where the FL CW is configured to frequency hop according to a FL data frequency hopping pattern or the FL CW frequency hopping pattern.

Another innovative aspect of the subject matter described in this disclosure may be implemented in an apparatus for wireless communication, such as an ambient IoT device. The apparatus includes one or more memories, and one or more processors each communicatively coupled with at least one of the one or more memories. The one or more processors, individually or in any combination, are operable to cause the apparatus to obtain a FL CW modulated with FL data, the FL CW configured to frequency hop according to a FL data frequency hopping pattern or a FL CW frequency hopping pattern; and send BL data in response to the FL data using the CW, the BL data configured to frequency hop according to a BL frequency hopping pattern or the FL CW frequency hopping pattern.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B shows a diagram illustrating an example disaggregated base station architecture.

FIG. 2A is a diagram illustrating an example of a first subframe within a 5G NR frame structure.

FIG. 2B is a diagram illustrating an example of DL channels within a 5G NR subframe.

FIG. 2C is a diagram illustrating an example of a second subframe within a 5G NR frame structure.

FIG. 2D is a diagram illustrating an example of UL channels within a 5G NR subframe.

FIG. 3 is a block diagram of a base station (BS) in communication with a user equipment (UE) in an access network.

FIG. 4A is a diagram illustrating an example of a conventional radio frequency identification (RFID) system.

FIG. 4B is a diagram illustrating an example chart of electromagnetic (EM) strength over time for communication between an RFID reader and an RFID tag.

FIG. 4C is a diagram illustrating an example of an ambient Internet of Things (A-IoT) system in which a base station communicates with an RFID tag directly.

FIG. 4D is a diagram illustrating an example of an A-IoT system in which a base station communicates with the RFID tag through a UE acting as a relay.

FIG. 5A is a diagram illustrating an example of a monostatic backscatter system where a radio frequency (RF) source and an RF reader are a same device with a single antenna.

FIG. 5B is a diagram illustrating an example of a monostatic backscatter system where an RF source and an RF reader are a same device with separate antennas.

FIG. 5C is a diagram illustrating an example of a bistatic configuration where an RF source and an RF reader are separate devices.

FIG. 6 is a diagram illustrating an example of A-IoT communication, where an A-IoT RF source sends forward link (FL) data and a FL continuous wave or carrier wave (CW) over the FL to an ambient IoT device such as an RFID tag, and the tag sends Backward Link (BL) data to the A-IoT reader in response.

FIG. 7 is a diagram showing an example of a chart illustrating signal power and frequencies for different tag subchannel sets with respect to FL data or CW power.

FIG. 8 is a diagram showing an example of a chart illustrating a frequency over time of FL data and FL CWs from an A-IoT RF source to an ambient IoT device over FL, and of BL data from an ambient IoT device to an A-IoT reader over BL, using FL data and FL CW center frequencies and bandwidths, as well as tag reception bandwidths.

FIG. 9 is a diagram showing an example of a chart showing frequency over time of FL data and FL data retransmissions and FL CWs from an RF source, and BL data and BL data retransmissions from an ambient IoT device.

FIG. 10 is a diagram showing an example of a chart of frequency over time for FL data transmitted according to different FL data frequency hopping patterns.

FIG. 11 is a diagram showing an example of a chart showing frequency over time for frequency hopping FL queries during an initial access stage.

FIG. 12 is a diagram showing an example of a chart of frequency over time for FL data and frequency hopping FL CW, and a corresponding chart of tag Rx power over time for the FL data and frequency hopping FL CW.

FIG. 13 is a diagram showing an example of a chart of frequency over time for FL data and frequency hopping FL CW, where the FL CW frequency hops across different subchannels of a FL CW subchannel set.

FIG. 14 is a diagram showing an example of a chart of frequency over time for frequency hopping FL data and FL CW.

FIG. 15 is a diagram showing an example of a chart of frequency over time for FL data and frequency hopping FL CW.

FIG. 16 is a diagram showing an example of a chart of frequency over time for frequency hopping FL data and frequency hopping FL CW.

FIG. 17 is a diagram showing an example of a chart showing frequency over time of an FL data transmission and BL data responsive to the FL data transmission and double frequency shifted with respect to an FL CW.

FIG. 18 is a diagram showing an example of a chart showing frequency over time of BL data transmitted in double sideband signals in different BL data subchannel sets.

FIG. 19 is a diagram showing another example of a chart showing frequency over time of BL data transmitted in double sideband signals in different BL data subchannel sets.

FIG. 20 is a diagram showing an example of a chart showing frequency over time of BL data transmitted in double sideband signals in different BL data subchannels of the same or different BL data subchannel sets.

FIG. 21 is a diagram showing an example of an RF source transmitting FL queries in FL data subchannels for tag discovery.

FIG. 22 is a flowchart of an example method of wireless communication performable at an RF source.

FIG. 23 is a flowchart of an example method of wireless communication performable at an RF reader.

FIG. 24 is a flowchart of an example method of wireless communication performable at an ambient IoT device.

FIG. 25 is a diagram illustrating an example of a hardware implementation for an apparatus that may constitute an RF source, an RF reader, or an ambient IoT device.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In traditional Radio Frequency Identification (RFID) systems and Ambient Internet of Things (A-IoT) systems, communication efficiency and reliability may be limited due to fixed frequency ranges and lack of frequency hopping mechanisms. To address this problem, aspects of the present disclosure provide a wireless communication system that enhances frequency hopping mechanisms for forward link (FL) data, forward link continuous wave (FL CW), and backward link (BL) data. By implementing different frequency hopping patterns and configurations, the communication efficiency and reliability between an RF source, ambient IoT devices, and an A-IoT reader may be improved.

One aspect of the present disclosure introduces frequency hopping in the BL data of an ambient IoT device, such as a tag. Another aspect of the present disclosure provides frequency hopping in the FL CW. Additionally, aspects of the present disclosure provide signaling for communicating frequency hopping configurations between devices, such as between a base station and a UE or between a UE and a tag. This allows for the configuration of frequency hopping patterns and the allocation of frequency resources to be transferred between devices, enabling efficient and flexible communication in the A-IoT system. By addressing these and other aspects, the present disclosure allows for efficient communication between the A-IoT RF source, ambient IoT devices, and the A-IoT reader while also accommodating different classes of ambient IoT devices with varying frequency shift capabilities.

Accordingly, various aspects of the subject matter described in this disclosure relate generally to wireless communication and more particularly to communication between radio frequency (RF) sources, readers, and ambient Internet of Things (IoT) devices. Some aspects specifically address frequency hopping techniques for forward link continuous wave, FL data, and backward link data to improve communication efficiency and reliability in IoT systems. In some examples, an RF source sends an FL CW modulated with FL data, with the FL CW configured to frequency hop according to an FL data frequency hopping pattern or an FL CW frequency hopping pattern. The RF source also configures an ambient IoT device to send BL data in response to the FL data using the FL CW, with the BL data configured to frequency hop according to a BL frequency hopping pattern or the FL CW frequency hopping pattern. In other examples, an RF reader obtains BL data from an ambient IoT device, with the BL data configured to frequency hop according to a BL frequency hopping pattern or an FL CW frequency hopping pattern. Additionally, an ambient IoT device may obtain an FL CW modulated with FL data and send BL data in response to the FL data using the CW, with the BL data configured to frequency hop according to a BL frequency hopping pattern or the FL CW frequency hopping pattern.

Particular aspects of the subject matter described in this disclosure can be implemented to realize one or more of the following potential advantages. By having an RF source send, and an ambient IoT device obtain, an FL CW modulated with FL data and configuring the FL CW to frequency hop according to an FL data frequency hopping pattern, the A-IoT system may improve communication efficiency and reliability by synchronizing the frequency hopping behavior of the FL CW with the FL data. This synchronization may lead to consistent and coordinated communication between the RF source, ambient IoT devices, and RF readers, enabling the system to adapt to varying channel conditions and provide improved communication capabilities in different scenarios. On the other hand, configuring the FL CW to frequency hop according to an FL CW frequency hopping pattern independent of the FL data frequency hopping pattern may provide more flexibility in managing the frequency resources for the FL CW. This independence allows the system to optimize the FL CW frequency hopping behavior based on the specific requirements of the IoT devices involved, without being constrained by the FL data frequency hopping pattern. Additionally, configuring an ambient IoT device to send, and an RF reader to obtain, BL data in response to the FL data using the FL CW, with the BL data configured to frequency hop according to a BL frequency hopping pattern or the FL CW frequency hopping pattern, may further enhance communication capabilities in various scenarios. When the BL data frequency hopping is based on the BL frequency hopping pattern, the system may provide more control over the BL data frequency hopping behavior, allowing the system to adapt to the specific requirements of the IoT devices involved. In contrast, when the BL data frequency hopping is based on the FL CW frequency hopping pattern, the system may achieve more synchronized communication between the RF source, ambient IoT devices, and RF readers, as the BL data frequency hopping behavior is dependent on the FL CW frequency hopping behavior, providing consistent and coordinated communication between the devices.

Other aspects of the disclosure address various configurations and triggering conditions for frequency hopping in FL data, FL CW, and BL data, as well as the relationship between FL data subchannels, FL CW subchannels, and BL data subchannels in the A-IoT system. For example, by providing granularity in frequency hopping behavior and accommodating different classes of ambient IoT devices with varying frequency shift abilities, the A-IoT system may further improve communication performance. Defining conditions for triggering frequency hopping in FL data, FL CW, and BL data may help the A-IoT system adapt to scenarios where channel conditions are poor or when retransmissions are called for. Moreover, configuring the relationship between FL data subchannels, FL CW subchannels, and BL data subchannels in the A-IoT system allows for more efficient and flexible communication between the RF source, ambient IoT devices, and RF readers, enabling the system to adapt to varying channel conditions and provide improved communication capabilities in different scenarios.

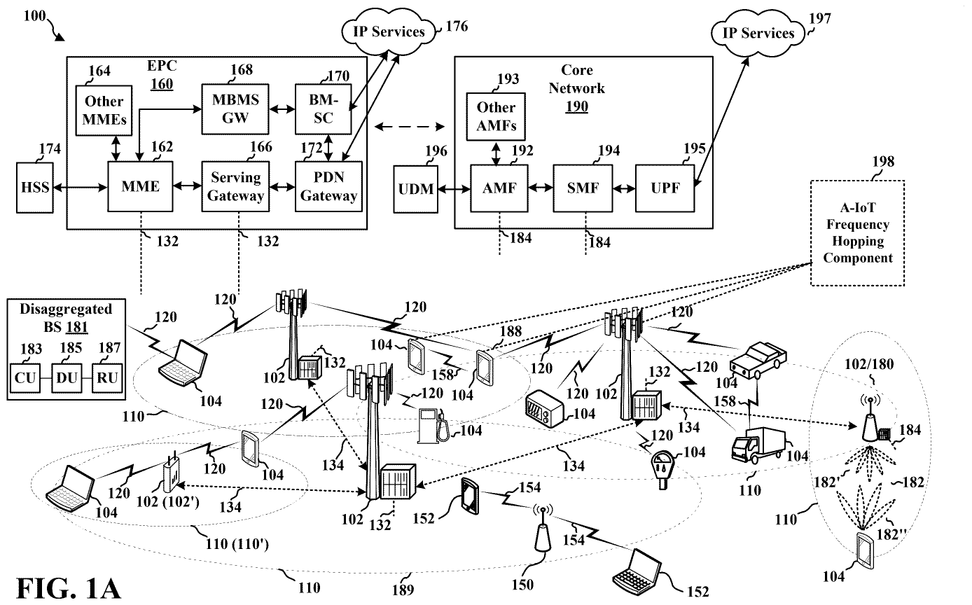

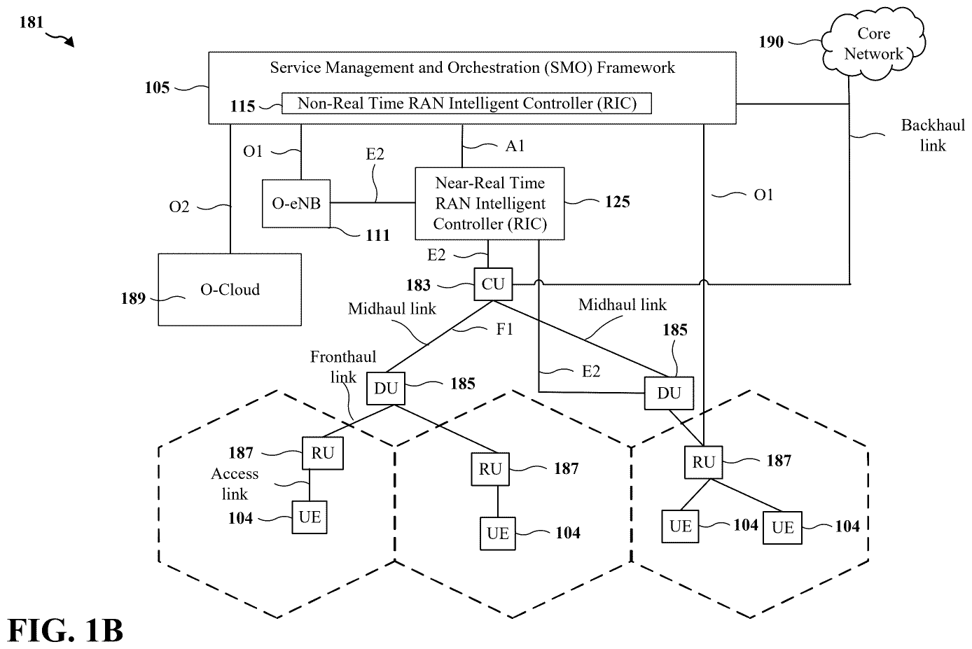

FIG. 1A is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G NR systems, may be arranged in multiple manners with various components or constituent parts. In a 5G NR system, or network, a network node, a network entity, a network device, a mobility element of a network, a RAN node, a core network node, a network element, or a network equipment, such as a BS, or one or more units (or one or more components) performing base station functionality, may be implemented in an aggregated or disaggregated architecture. For example, a BS (such as a Node B (NB), eNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station 181 may be configured to utilize a protocol stack that is physically or logically distributed among two or more units (such as one or more central units (CU), one or more distributed units (DUs), or one or more radio units (RUs)). In some aspects, a CU 183 may be implemented within a RAN node, and one or more DUs 185 may be co-located with the CU, or alternatively, may be geographically or virtually distributed throughout one or multiple other RAN nodes. The DUs may be implemented to communicate with one or more RUs 187. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

FIG. 1B shows a diagram illustrating an example disaggregated base station 181 architecture. The disaggregated base station 181 architecture may include one or more CUs 183 that may communicate directly with core network 190 via a backhaul link, or indirectly with the core network 190 through one or more disaggregated base station units (such as a Near-Real Time RIC 125 via an E2 link, or a Non-Real Time RIC 115 associated with a Service Management and Orchestration (SMO) Framework 105, or both). A CU 183 may communicate with one or more DUs 185 via respective midhaul links, such as an F1 interface. The DUs 185 may communicate with one or more RUs 187 via respective fronthaul links. The RUs 187 may communicate respectively with UEs 104 via one or more radio frequency (RF) access links. In some implementations, the UE 104 may be simultaneously served by multiple RUs 187.

Each of the units, i.e., the CUS 183, the DUs 185, the RUs 187, as well as the Near-RT RICs 125, the Non-RT RICs 115 and the SMO Framework 105, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 183 may host higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 183. The CU 183 may be configured to handle user plane functionality (i.e., Central Unit-User Plane (CU-UP)), control plane functionality (i.e., Central Unit-Control Plane (CU-CP)), or a combination thereof. In some implementations, the CU 183 may be logically split into one or more CU-UP units and one or more CU-CP units. The CU-UP unit may communicate bidirectionally with the CU-CP unit via an interface, such as the El interface when implemented in an O-RAN configuration. The CU 183 may be implemented to communicate with the DU 185, as necessary, for network control and signaling.

The DU 185 may correspond to a logical unit that includes one or more base station functions to control the operation of one or more RUs 187. In some aspects, the DU 185 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 185 may further host one or more low PHY layers. Each layer (or module) may be implemented with an interface configured to communicate signals with other layers (and modules) hosted by the DU 185, or with the control functions hosted by the CU 183.

Lower-layer functionality may be implemented by one or more RUs 187. In some deployments, an RU 187, controlled by a DU 185, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 187 may be implemented to handle over the air (OTA) communication with one or more UEs 104. In some implementations, real-time and non-real-time aspects of control and user plane communication with the RU(s) 187 may be controlled by the corresponding DU 185. In some scenarios, this configuration may enable the DU(s) 185 and the CU 183 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements, which may be managed via an operations and maintenance interface (such as an O1 interface). For virtualized network elements, the SMO Framework 105 may be configured to interact with a cloud computing platform (such as an open cloud (O-Cloud) 189) to perform network element life cycle management (such as to instantiate virtualized network elements) via a cloud computing platform interface (such as an O2 interface). Such virtualized network elements may include, but are not limited to, CUs 183, DUs 185, RUs 187 and Near-RT RICs 125. In some implementations, the SMO Framework 105 may communicate with a hardware aspect of a 4G RAN, such as an open eNB (O-eNB) 111, via an O1 interface. Additionally, in some implementations, the SMO Framework 105 may communicate directly with one or more RUs 187 via an O1 interface. The SMO Framework 105 also may include the Non-RT RIC 115 configured to support functionality of the SMO Framework 105.

The Non-RT RIC 115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 183, one or more DUs 185, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

Referring to FIGS. 1A and 1B, in certain aspects, the UE 104, aggregated base station (base station 102), or one or more components of disaggregated base station 181, may be an RF source including A-IoT frequency hopping component 198 that is configured to send a forward link (FL) continuous wave (CW) modulated with FL data and configure an ambient Internet of Things (IoT) device to send backward link (BL) data in response to the FL data using the FL CW. In other aspects, the UE 104 may be an RF reader including A-IoT frequency hopping component 198 that is configured to obtain BL data from an ambient IoT device, the BL data configured to frequency hop according to a BL frequency hopping pattern or a FL CW frequency hopping pattern. In other aspects, the UE 104 may be an ambient IoT device including A-IoT frequency hopping component 198 that is configured to obtain a FL CW modulated with FL data, the FL CW configured to frequency hop according to a FL data frequency hopping pattern or a FL CW frequency hopping pattern, and send BL data in response to the FL data using the CW, the BL data configured to frequency hop according to a BL frequency hopping pattern or the FL CW frequency hopping pattern.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

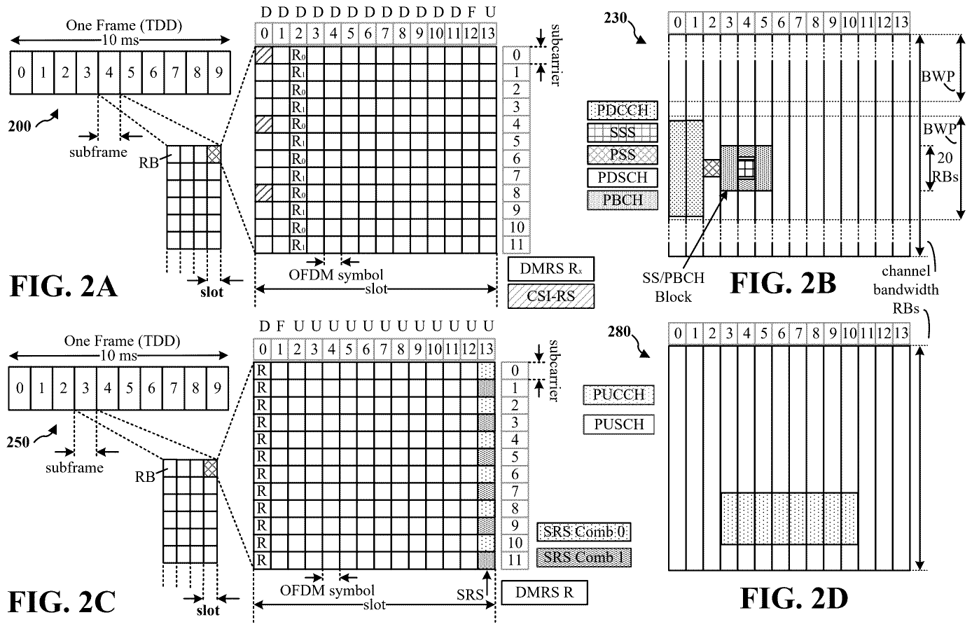

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2\hat{ }μ*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE may determine a physical cell identifier (PCI). Based on the PCI, the UE may determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data and may additionally be used to carry a buffer status report (BSR), a power headroom report (PHR), and/or UCI.

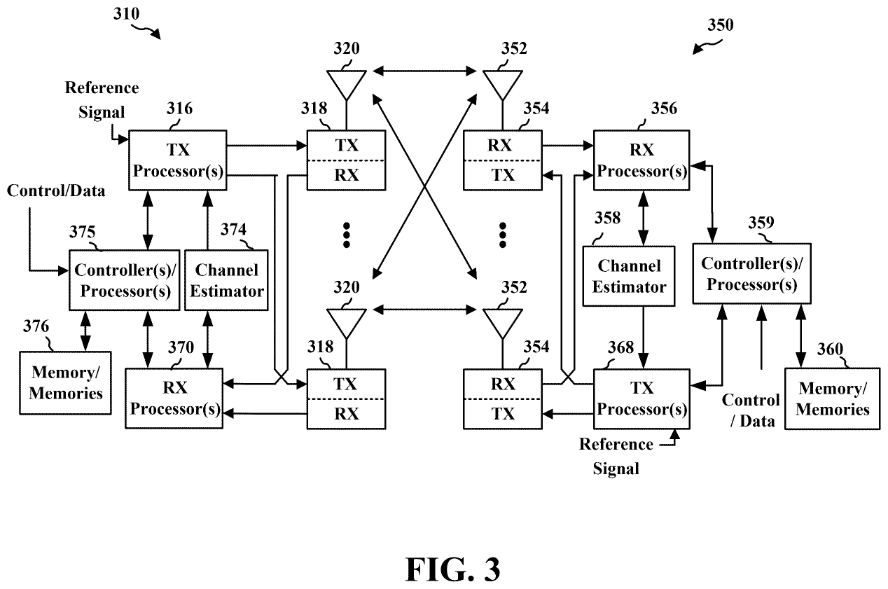

FIG. 3 is a block diagram of a first wireless device 310 in communication with a second wireless device 350 in an access network. In one example, first wireless device 310 may be a UE 104, an aggregated base station such as base station 102/180, or a component of a disaggregated base station, such as CU 183 or DU 185, acting as an RF source, and second wireless device 350 may be a UE 104 acting as an ambient IoT device. In another example, first wireless device 310 may be a UE 104 acting as an ambient IoT device, and second wireless device 350 may be a UE 104, an aggregated base station such as base station 102/180, or a component of a disaggregated base station, such as CU 183 or DU 185, acting as an RF reader. In other examples, first wireless device 310 and second wireless device 350 may respectively be other network entities such as described with respect to FIG. 1A or 1B acting as an RF source, RF reader, or ambient IoT device.

In the DL, IP packets from the EPC 160 may be provided to one or more controllers/processors 375. The one or more controllers/processors 375 implement layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The one or more controllers/processors 375 provide RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer protocol data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The one or more transmit (TX) processors 316 and the one or more receive (RX) processors 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The one or more TX processors 316 handle mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the second wireless device 350. Each spatial stream may then be provided to a different antenna 320 via a separate transmitter 318TX. Each transmitter 318TX may modulate an RF carrier with a respective spatial stream for transmission.

At the second wireless device 350, each receiver 354RX receives a signal through its respective antenna 352. Each receiver 354RX recovers information modulated onto an RF carrier and provides the information to the one or more receive (RX) processors 356. The one or more TX processors 368 and the one or more RX processors 356 implement layer 1 functionality associated with various signal processing functions. The one or more RX processors 356 may perform spatial processing on the information to recover any spatial streams destined for the second wireless device 350. If multiple spatial streams are destined for the second wireless device 350, they may be combined by the one or more RX processors 356 into a single OFDM symbol stream. The one or more RX processors 356 then convert the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the first wireless device 310. These soft decisions may be based on channel estimates computed by the channel estimator 358. The soft decisions are then decoded and deinterleaved to recover the data and control signals that were originally transmitted by the first wireless device 310 on the physical channel. The data and control signals are then provided to the one or more controllers/processors 359, which implement layer 3 and layer 2 functionality.

The one or more controllers/processors 359 may each be associated with one or more memories 360 that store program codes and data. The one or more memories 360, individually or in any combination, may be referred to as a computer-readable medium. In the UL, the one or more controllers/processors 359 provide demultiplexing between transport and logical channels, packet reassembly, deciphering, header decompression, and control signal processing to recover IP packets from the EPC 160. The one or more controllers/processors 359 are also responsible for error detection using an ACK and/or NACK protocol to support HARQ operations.

Similar to the functionality described in connection with the DL transmission by the first wireless device 310, the one or more controllers/processors 359 provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the first wireless device 310 may be used by the one or more TX processors 368 to select the appropriate coding and modulation schemes, and to facilitate spatial processing. The spatial streams generated by the one or more TX processors 368 may be provided to different antenna 352 via separate transmitters 354TX. Each transmitter 354TX may modulate an RF carrier with a respective spatial stream for transmission.

The UL transmission is processed at the first wireless device 310 in a manner similar to that described in connection with the receiver function at the second wireless device 350. Each receiver 318RX receives a signal through its respective antenna 320. Each receiver 318RX recovers information modulated onto an RF carrier and provides the information to one or more RX processors 370.

The one or more controllers/processors 375 may each be associated with one or more memories 376 that store program codes and data. The one or more memories 376, individually or in any combination, may be referred to as a computer-readable medium. In the UL, the one or more controllers/processors 375 provide demultiplexing between transport and logical channels, packet reassembly, deciphering, header decompression, control signal processing to recover IP packets from the second wireless device 350. IP packets from the one or more controllers/processors 375 may be provided to the EPC 160. The one or more controllers/processors 375 are also responsible for error detection using an ACK and/or NACK protocol to support HARQ operations.

At least one of the one or more TX processors 316, 368, the one or more RX processors 356, 370, and the one or more controllers/processors 359, 375, may be configured to perform aspects in connection with A-IoT frequency hopping component 198 of FIG. 1A.

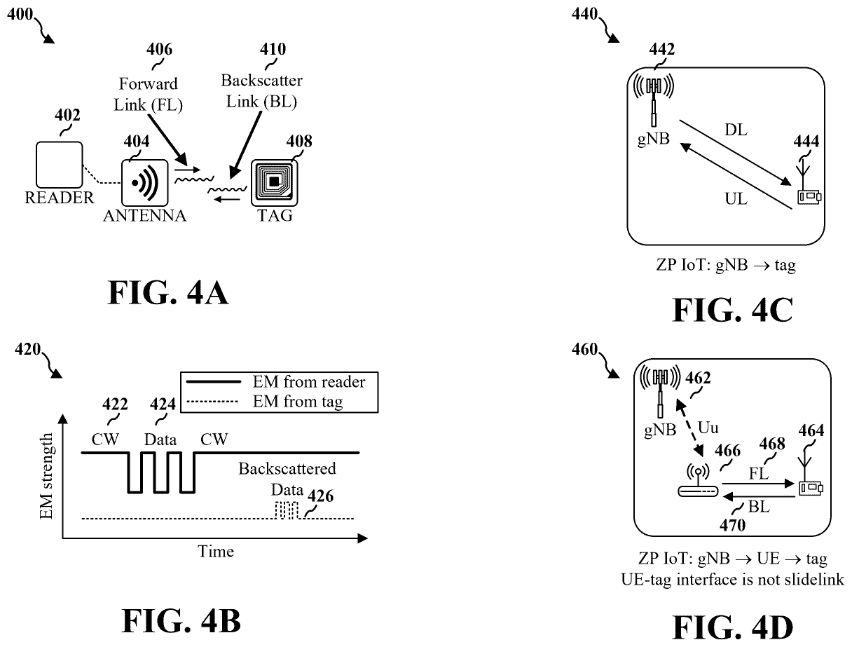

FIG. 4A illustrates an example of a traditional Radio Frequency Identification (RFID) system 400. In such systems, a reader 402 is connected to an antenna 404. The antenna 404 sends a Forward Link (FL) signal 406 to a tag 408. The tag 408 then backscatters a Backscatter Link (BL) signal 410 to the antenna 404. Generally, the carrier wave or continuous wave for the backscatter is provided from the reader 402, and the tag 408 does not generate the continuous wave by itself.

FIG. 4B depicts a chart 420 representing the electromagnetic (EM) strength over time, which demonstrates the communication between the reader and the tag in traditional RFID system 400. The chart 420 displays the amplitude or EM strength of a carrier wave (CW) 422 originating from the reader, which remains at a high level for a certain duration. Following this period, the reader's signal represents modulated data 424 transmitted with fluctuating amplitude. Once the modulated data 424 has been transmitted, the reader's signal returns to a high amplitude, signifying the CW 422 once again. In response to the CW containing modulated data from the reader, the tag transmits a signal modulated with backscattered data 426. The amplitude of this backscattered data 426, received by the reader, varies as the tag reacts to the reader's signal.

Aspects of the present disclosure relate to a wireless communication system that extends from traditional Radio Frequency Identification (RFID) technology to Zero-Power Internet of Things (ZP-IoT) or Ambient IoT (A-IoT) technology. In contrast to traditional RFID system 400, in the topology of an A-IoT system, base station 102/180 may communicate with an ambient IoT device such as tag 408, directly such as shown in FIG. 4C, or through a UE acting as a relay such as shown in FIG. 4D. To implement an A-IoT system, an interface may be defined between the ambient IoT device and the base station (in FIG. 4C) or the UE (in FIG. 4D). An ambient IoT device, such as an RFID tag in the A-IoT system, may support energy harvesting and energy storage, allowing it to capture energy from various sources such as radio waves, sunlight, wind, and heat. Moreover, the A-IoT system may support not only backscatter tags such as passive or semi-passive tags, but also active tags. A main difference between backscatter tags and active tags is that backscatter tags rely on an external device such as a reader to provide the carrier wave, while active tags generate their own carrier wave for transmission. Supporting both types of tags allows the A-IoT system to offer more flexibility and functionality than traditional RFID systems.

FIG. 4C illustrates an example of a ZP-IoT system 440 where a base station 442 such as base station 102/180 communicates directly with an ambient IoT device such as a tag 444 using downlink (DL) and uplink (UL) signals. In contrast, FIG. 4D presents an example of a ZP-IoT system 460 where a base station 462 such as base station 102/180 communicates with an ambient IoT device such as a tag 464 through a relaying device 466 such as a sidelink relay or UE 104 partially via a Uu interface between the base station 462 and the relaying device 466, with FL 468 and BL 470 signals being communicated over a non-sidelink interface between the relaying device 466 and the tag 464. In such A-IoT systems, the ambient IoT devices are designed to be low-cost and low-power, making them suitable for various IoT applications. The A-IoT systems may also support energy harvesting and energy storage, allowing the tags to capture and store energy from various sources for later use. This enables the A-IoT system to be more versatile and adaptable compared to traditional RFID systems.

Aspects of the present disclosure also refer to different configurations for communication between RF sources, readers, and tags, including monostatic and bistatic configurations. A monostatic configuration involves a single device that simultaneously transmits and receives signals, while a bistatic configuration involves two separate devices, one for transmitting and one for receiving. These configurations may be applied to both traditional RFID systems and the A-IoT systems discussed in the present disclosure.

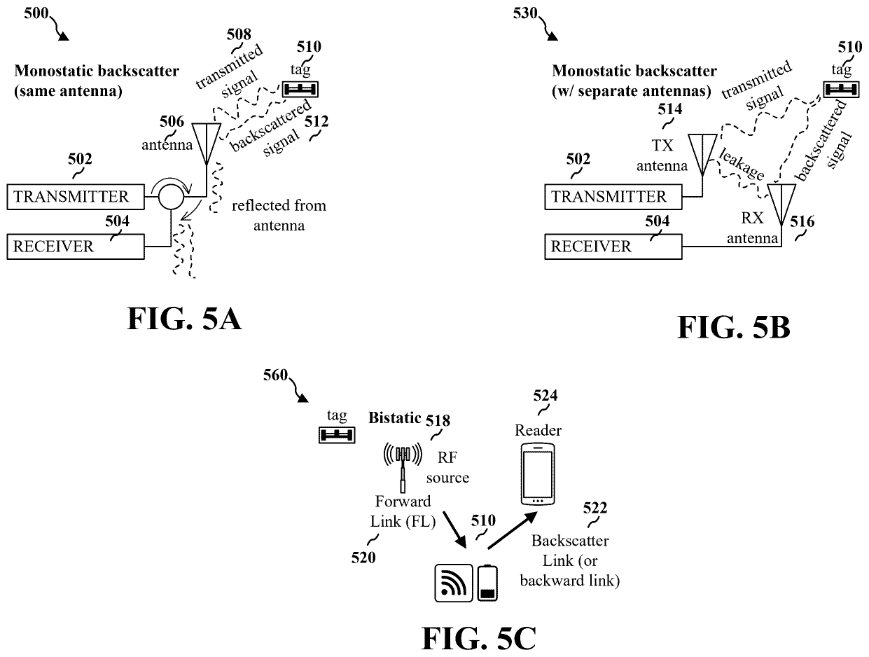

FIG. 5A illustrates an example of a monostatic backscatter system 500 with a single antenna. In a monostatic configuration, the RF source and the reader are the same device, as typically seen in RFID systems. Moreover, in this configuration, a transmitter 502 and a receiver 504 are coupled to the same antenna 506. A transmitted signal 508 is sent from the transmitter 502 to an ambient IoT device such as a tag 510, which in response sends a backscattered signal 512 to the antenna 506 to be sent to the receiver 504. The transmitted signal 508 may also be reflected from the antenna 506 into the receiver 504.

FIG. 5B shows an example of a monostatic backscatter system 530 with separate antennas. Unlike the example of FIG. 5A, in this configuration, the transmitter 502 is coupled to a TX antenna 514, and the receiver 504 is coupled to an RX antenna 516. The TX antenna 514 sends the transmitted signal 508 to the tag 510, which in turn sends the backscattered signal 512 to the RX antenna 516. Leakage from the backscattered signal 512 at the RX antenna 516 may be intercepted by the TX antenna 514.

FIG. 5C illustrates an example of a bistatic configuration 560 where the RF source and the reader are separate devices. Here, an RF source, such as a base station 518 corresponding to base station 102/180, sends a signal on a forward link 520 to the tag 510. The tag or ambient IoT device in turn sends the backscattered signal over a backward link 522 to a separate reader 524 or receiver.

In the context of RFID systems and A-IoT systems such as described with respect to FIGS. 4A-4D and 5A-5C, various terms have been referenced in connection with the present disclosure. Here, “reader” refers to an RFID integrator capable of transmitting and receiving signals with a tag. “Forward Link” (FL) refers to a communication link or channel that carries a signal transmitted from an RF source to an ambient IoT device such as a tag. “RF source” refers to a device that transmits the FL signal. “Forward Link Continuous Wave” (FL CW) refers to an unmodulated FL signal that may be used to power up and provide a carrier wave for the ambient IoT device. “FL data” represents modulated FL information, which may include commands, acknowledgments (ACK), or negative acknowledgments (NACK). “Backward Link” (BL) refers to a communication link or channel that carries a signal transmitted from an ambient IoT device to a reader. “BL data” refers to information transmitted in the BL signal, which may include tag ACK/NACK, new data from the tag to be transmitted, or backscattered data. In some cases, the reader and RF source may be the same device (in a monostatic configuration such as illustrated in FIGS. 5A and 5B), which same device may collectively be referred to as a reader.

In an A-IoT system, a combination of modulated FL data and unmodulated FL CW is used to communicate with tags. The FL data is transmitted using a multi-subcarrier waveform, while the FL CW is transmitted using a single-subcarrier waveform. This approach enables efficient communication between the A-IoT RF source, the tag, and the A-IoT reader. The ambient IoT device receives the FL data and FL CW within a predefined Rx bandwidth, and responds by transmitting BL data in a double sideband signal, also referred to as a double frequency shift with respect to the FL CW.

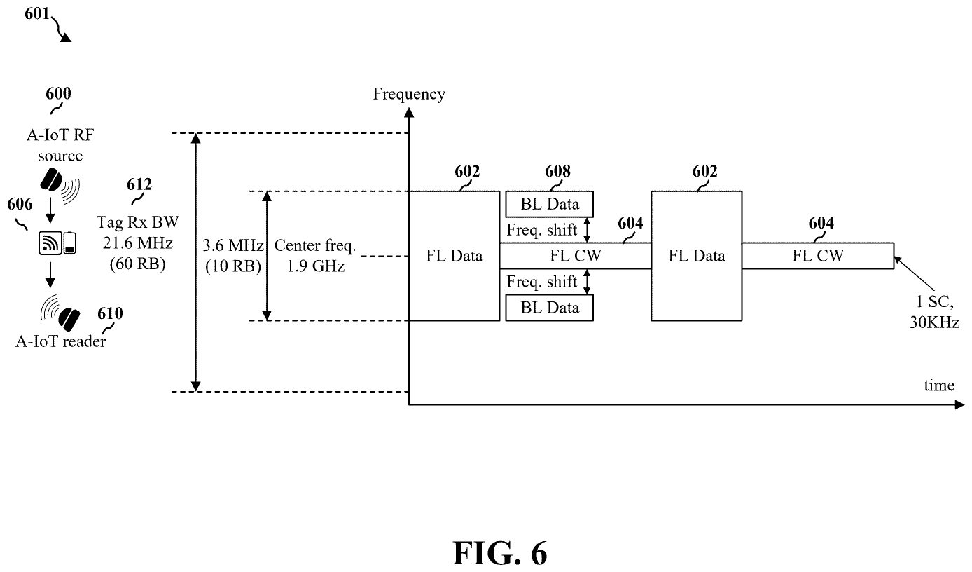

FIG. 6 illustrates an example 601 where an A-IoT RF source 600 sends FL data 602 and FL CW 604 over the FL to the ambient IoT device such as tag 606, and the ambient IoT device sends BL data 608 to the A-IoT reader 610 in response to the FL data 602. In this example, the FL data 602 and FL CW 604 have a center frequency of 1.9 GHz, the FL CW 604 has a bandwidth of one subcarrier (30 KHz), and the FL data 602 has a bandwidth of 10 RBs spanning 3.6 MHz, although one or more of these quantities may be different in other examples. As illustrated, the RF source 600 transmits FL data 602 followed by FL CW 604, and periodically repeats with subsequent transmissions of FL data 602 and FL CW 604. The ambient IoT device such as tag 606 receives the FL data 602 and FL CW 604 within an Rx bandwidth 612 which is larger than the FL data bandwidth. In this example, the Rx bandwidth 612 is 60 RBs, spanning 21.6 MHz, although this quantity may be different in other examples. This Rx bandwidth 612 may be predefined to compensate for the difficulty in passive or semi-passive tags to tune the Rx band. In response to the FL data 602, the tag transmits BL data 608 in a double sideband signal, or at a double frequency shift (positive and negative) with respect to the FL CW 604. The BL data 608 may be transmitted within the bandwidth of the FL data 602 as illustrated.

In the A-IoT system, different classes of ambient IoT devices such as tags may have varying frequency shift abilities, and Frequency Division Multiplexing (FDM) in subchannels may be supported in the BL. Here, a subchannel represents the smallest granularity of frequency resources that one ambient IoT device may occupy in the BL. Thus, in this context, one tag may correspond to one subchannel. Moreover, a subchannel set refers to a collection of subchannels that may be occupied by different tags or by a single tag with frequency hopping. Different classes of tags may have separate subchannel sets, allowing for efficient allocation of frequency resources and communication between the A-IoT RF source, the ambient IoT devices, and the A-IoT reader. For example, this configuration may allow for efficient organization of tag responses in the frequency domain, accommodating different classes of tags with varying frequency shift abilities and enabling effective communication between the A-IoT RF source, the tags, and the A-IoT reader.

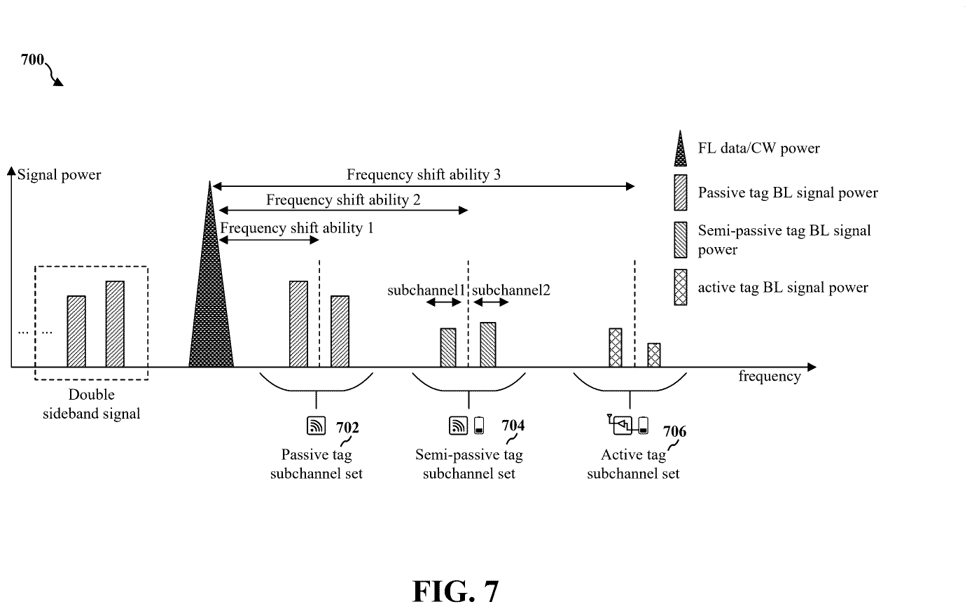

FIG. 7 shows an example of a chart 700 illustrating the signal power and frequencies for different tag subchannel sets with respect to FL data or CW power. The different subchannel sets may be transmitted in double sideband signals or configured with different double frequency shifts with respect to the FL data or CW center frequency. For example, a passive tag subchannel set 702 or a subchannel set configured for passive tags may be positioned at a first frequency shift with respect to the FL data or CW center frequency, on both sides of the FL data or CW center frequency in the form of a double sideband signal as illustrated. The passive tag subchannel set 702 may have a first set of BL signal powers corresponding to different subchannels in the subchannel set. Similarly, a semi-passive tag subchannel set 704 may be configured at a second, larger frequency shift with respect to the FL data 602 or CW center frequency than that of the passive tag subchannel set 702. The semi-passive tag subchannel set 704 may include double sideband signals with BL signal power per subchannel less than the signal powers of the passive tag subchannel set 702. Likewise, an active tag subchannel set 706 may be configured at a third, even larger frequency shift with respect to the FL data 602 or CW center frequency than that of semi-passive tag subchannel set 704. The active tag subchannel set 706 may include double sideband signals with BL signal power per subchannel less than the signal powers of the semi-passive tag subchannel set 704. Although these subchannel sets in FIG. 7 refer specifically to tags, it should be understood the subchannel sets may be associated with other ambient IoT devices.

The present disclosure relates to the enhancement of frequency hopping mechanisms in RFID systems. Enhancement may particularly be helpful for A-IoT systems that support semi-passive and active tags with longer communication ranges than in traditional RFID systems, since a longer communication range may result in more severe fading caused by multipath effects. While frequency hopping may handle frequency selective fading, as supported in ultra high frequency (UHF) RFID or a frequency hopping spread spectrum, efforts have been focused on configuring UE frequency hopping patterns in general, without addressing how frequency hopping may be supported specifically in an A-IoT system for both forward links and backward links. Thus, aspects of the present disclosure introduce backward link frequency hopping and provide enhancements to forward link frequency hopping, including forward link data and the forward link continuous wave, either of which may frequency hop between different subcarriers and subcarrier sets. To support or enhance frequency hopping in the A-IoT system in both the forward link and the backward link, aspects of the present disclosure describe configurations indicating how or when FL or BL frequency hopping is enabled or triggered, as well as define signaling for communicating such configurations. By addressing these aspects, the disclosure allows for efficient communication between the A-IoT RF source, the ambient IoT devices, and the A-IoT reader, accommodating different classes of ambient IoT devices with varying frequency shift abilities.

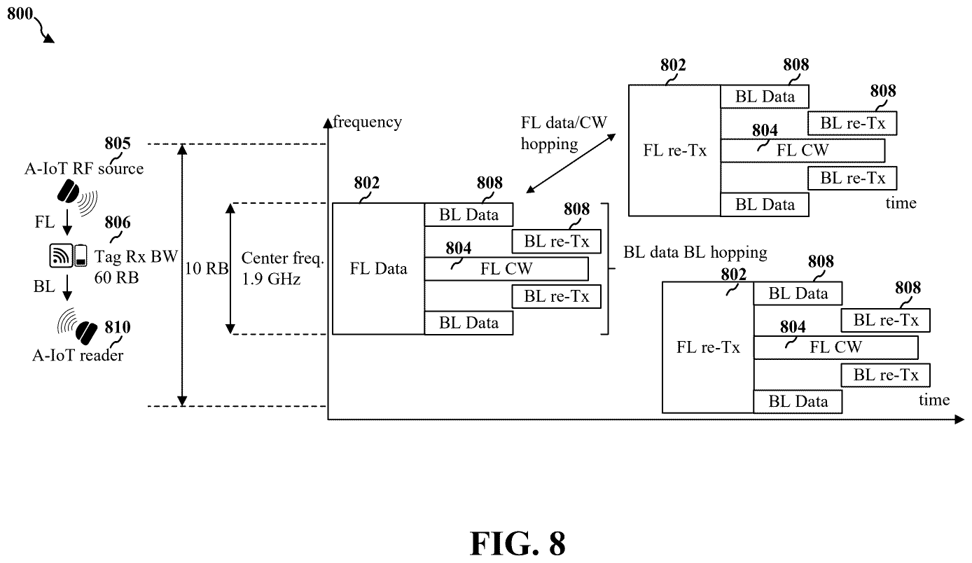

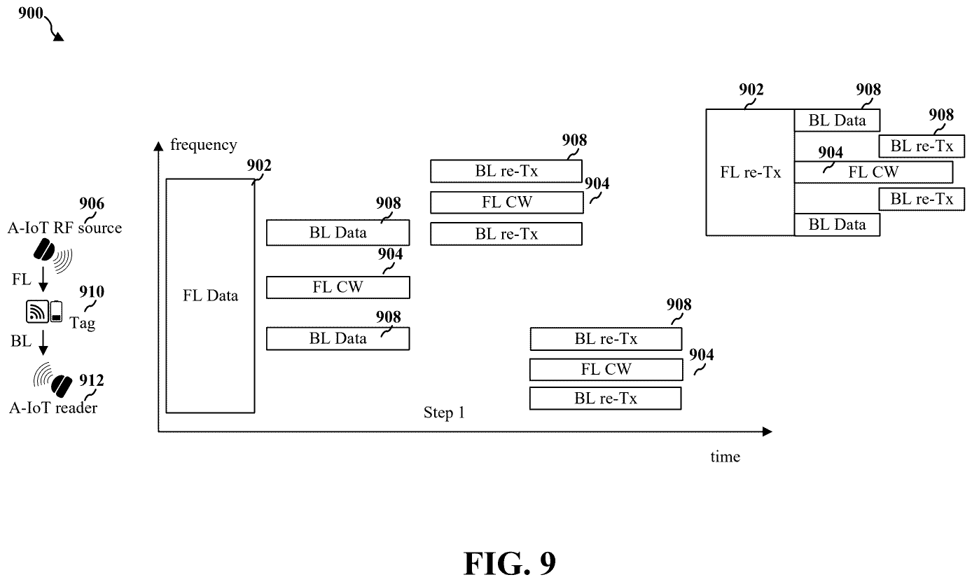

In a first example aspect, an ambient IoT device such as a tag with frequency hopping capability is provided. Initially, the tag receives one FL packet or data and sends feedback with one BL packet or data and one blind retransmission. Frequency hopping is introduced in the BL packets of the tag. Afterwards, if the reader does not receive the packets from the tag, the reader decides to apply FL data and CW hopping for FL retransmissions. In a second example aspect, the ambient IoT device may not have frequency hopping capability. Instead, in this example, frequency hopping is introduced in the FL CW instead, which results in the BL packets of the ambient IoT device frequency hopping with the FL CW. An illustration of the first example aspect may be shown in FIG. 8, while an illustration of the second example aspect may be shown in FIG. 9.

FIG. 8 shows an example of a chart 800 illustrating a frequency over time of FL data 802 and FL CWs 804 from an A-IoT RF source 805 to a tag 806 over FL, and of BL data 808 from the tag 806 to an A-IoT reader 810 over BL. Similar to the example of FIG. 6, the RF source 805 applies FL data 802 and FL CW 804 center frequencies and bandwidths, and the tag 806 or ambient IoT device applies tag Rx bandwidths. However, unlike the prior example of FIG. 6, here in this example, the BL data 808 frequency hops over the BL. For instance, retransmissions of the BL data 808 in response to initial FL data 802 may be transmitted in different double sideband signals, or double frequency shifted with respect to the FL CW 804 at a different frequency with respect to the FL CW 804, within the bandwidth of the FL data 802. If the reader 810 does not receive the BL data 808 or its retransmissions from the tag 806, the FL data 802 and FL CW 804 from the RF source frequency hop over the FL. For example, a retransmission of the FL data 802 and FL CW 804 may be transmitted at a different center frequency within the bandwidth of the tag Rx as illustrated in FIG. 8. The tag 806 or ambient IoT device may then again transmit BL data 808 and BL data retransmissions, which again frequency hop over the BL within the bandwidth of the frequency-hopped FL data 802. This process may continue with subsequent FL data 802 and FL CW 804 retransmissions hopping to different center frequencies and subsequent BL data retransmissions 808 hopping based on the FL data 802 and FL CW 804 frequencies accordingly.

FIG. 9 shows an example of a chart 900 depicting the frequency over time of FL data 902 and FL data retransmissions and FL CWs 904 from an RF source 906, and BL data 908 and BL data retransmissions from an ambient IoT device such as a tag 910. In this example, the FL CW 904 frequency hops independently of the center frequency of the FL data 902. After the RF source 906 transmits FL data 902 to the ambient IoT device such as tag 910, the RF source may transmit the initial, FL CW 904 at one frequency within the BW of the FL data 902, and then subsequent, FL CWs 904 at different frequencies within the BW of the FL data 902. The tag 910 sends BL data 908 in response to the FL data 902 in a double sideband signal, or at a double frequency shift with respect to the initial, FL CW 904, and the tag 910 similarly sends BL data retransmissions in a double sideband signal or at a double frequency shift with respect to the frequency hopping subsequent, FL CWs 904. The BL data 908 and its retransmissions are dependent on the center frequency of the FL CW 904. If an RF reader 912 does not receive the BL data 908 or its retransmissions, the RF source 906 may re-transmit the FL data 902 at a different center frequency in an FL data frequency hop. Following the FL data frequency hop, the RF source 906 may again transmit FL CWs 904 independently of the FL data 902 center frequency but within the frequency-hopped FL data 902 BW, or the RF source 906 may transmit FL CW 904 according to or dependent on the FL data 902 center frequency. The tag 910, in response to the FL CW 904, may similarly transmit BL data 908 and BL data retransmissions in response to the re-transmitted FL data 902 at double frequency shifts with respect to the FL CW(s) 904, whether the FL CWs 904 are frequency hopping or fixed.

In one aspect of the present disclosure, frequency hopping patterns for FL data, FL CW, and BL data may be introduced in the A-IoT system. These frequency hopping patterns may be predefined or indexed by a frequency hopping pattern index. Random frequency hopping may be considered as well. Frequency hopping of FL data within subchannels associated with a given frequency hopping pattern index, including FL data subchannels and FL data subchannel sets, may correspondingly occur. Here, an FL data subchannel represents the smallest granularity of frequency resources that FL data may occupy. In this disclosure, one FL data subchannel corresponds to one subchannel. An FL data subchannel set represents the set of resources that FL data may occupy. The defined subchannels and subchannel sets may be communicated between devices, such as between a base station and a UE or between a UE and a tag. This allows for the configuration of frequency hopping patterns and the allocation of frequency resources to be transferred between devices, enabling efficient and flexible communication in the A-IoT system. By defining frequency hopping patterns and indices for both FL and BL, the A-IoT system may provide improved communication capabilities.

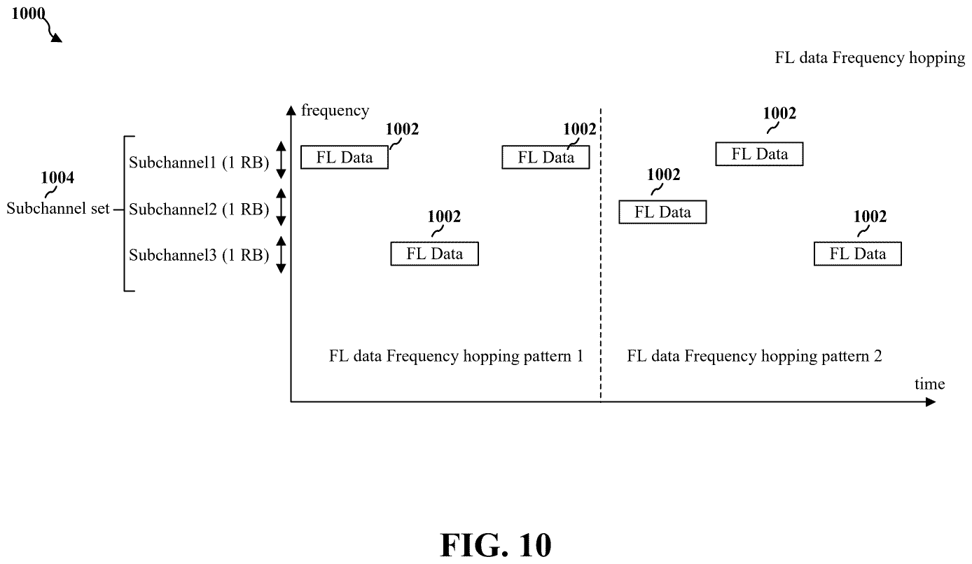

FIG. 10 illustrates an example of a chart 1000 of frequency over time for FL data 1002 transmitted according to different FL data frequency hopping patterns. A subchannel set 1004, including multiple subchannels, may be configured for the transmission of FL data 1002. In this example, the subchannels may each be 1 RB, although they may be different in other examples. The RF source may transmit FL data 1002 within respective subchannels of the subchannel set 1004 according to a given frequency hopping pattern. For example, in a first frequency hopping pattern, as illustrated in this example, the FL data 1002 may frequency hop between subchannels 1 and 3 over time. In a second frequency hopping pattern, as illustrated in this example, the FL data 1002 may frequency hop in the order of subchannels 2, 1, and 3 over time. Different frequency hopping patterns may be configured in other examples.

In one aspect of the present disclosure, frequency hopping in FL data may be triggered under various conditions. These conditions may include situations when the RF source aims to discover all nearby tags or other ambient IoT devices supported by RFID during an initial access or inventory stage, or when retransmission (Re-Tx) is to be sent because an FL or BL acknowledgment (ACK) or negative acknowledgment (NACK) or other response is missed for a certain number of times. Additionally, frequency hopping may be triggered when blind retransmission is enabled, or when a received power in the reader or tag is below a certain threshold. These conditions may be extended not only to FL data but also to FL CW and BL data, providing improved communication capabilities in the A-IoT system. By defining these conditions for triggering frequency hopping in FL data, FL CW, and BL data, the A-IoT system may provide improved communication capabilities, especially in scenarios where channel conditions are poor or when retransmissions are called for. This allows for more efficient and flexible communication between the RF source, tags, and other devices in the A-IoT system.

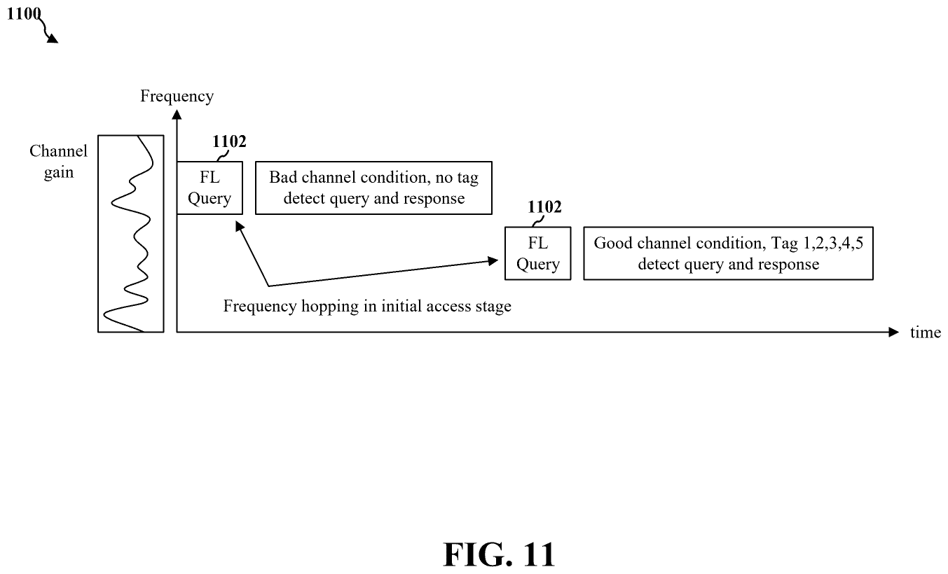

FIG. 11 illustrates an example 1100 of a chart showing frequency over time for frequency hopping, FL queries 1102 during an initial access stage. The FL queries 1102 may include FL data. Here, the RF source transmits an initial FL query to tags at one center frequency, but the channel gain at this frequency is small due to bad channel conditions. As a result, no tag may detect the FL query 1102 and respond. Accordingly, since the RF reader failed to receive BL data from any tag, the RF source may transmit another frequency hopped, FL query 1102 at a different center frequency. At this hop frequency, the channel gain may be large due to good channel conditions, and therefore nearby tags may detect the FL query 1102 and respond with BL data accordingly.

In various aspects of the present disclosure, frequency hopping in FL data may be applied to improve communication efficiency in the A-IoT system. This is because otherwise using the whole tag receiver frequency band for FL data, such as a 20 MHz band around 1.9 GHz center frequency, may result in low spectrum efficiency. In contrast, aspects of the present disclosure employ frequency hopping within a portion of the tag receiver frequency band, which may lead to better spectrum efficiency and improved communication capabilities. Furthermore, to compensate for frequency hopping consuming additional time domain resources, frequency hopping may be configured as a selectable feature in the A-IoT system. For example, frequency hopping may be triggered such as described above to occur during retransmission. Moreover, different readers may share resources by employing different frequency hopping patterns, which may improve overall efficiency.

In one aspect of the present disclosure, frequency hopping in FL CW may be provided to address communication efficiency challenges in the A-IoT system. Implementing FL CW frequency hopping may be beneficial because FL CW tends to occupy very limited frequency resources compared to FL data, resulting in more severe frequency selective fading. For example, FL CW might occupy only a single subcarrier, while FL data might occupy an entire resource block. Moreover, channel measurement capability may not be present in an ambient IoT device. Thus, by introducing frequency hopping in FL CW, the A-IoT system may provide enhanced communication capabilities and efficiency, particularly in scenarios where channel conditions are poor.

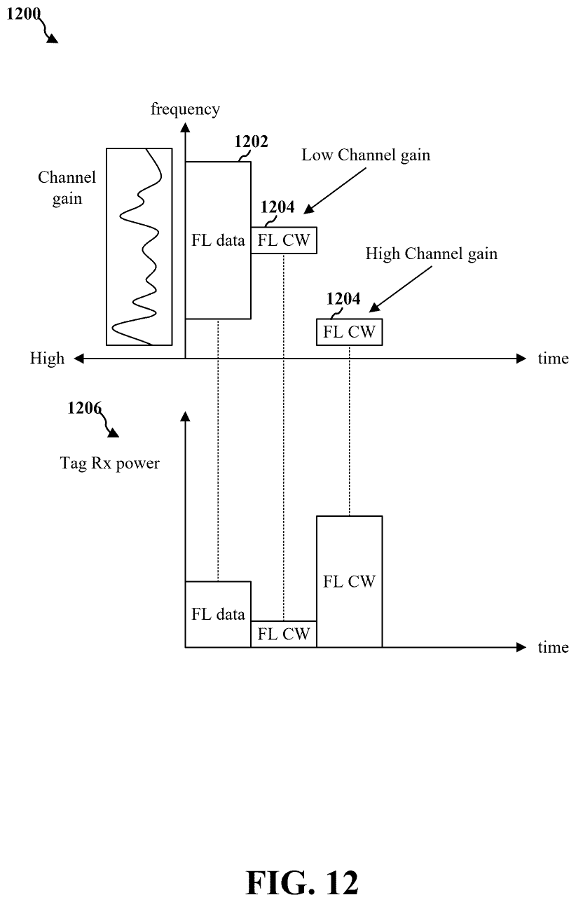

FIG. 12 shows an example of a chart 1200 of frequency over time for FL data 1202 and frequency hopping FL CW 1204, and a corresponding chart 1206 of tag Rx power over time for the FL data 1202 and frequency hopping, FL CW 1204. After the RF source transmits FL data 1202, the RF source may transmit an initial, FL CW 1204 at a frequency which happens to have low channel gain. As a result, the initial, FL CW 1204 may result in low tag Rx power, for example, lesser tag Rx power than that which may be applied for FL data 1202, due to frequency selective fading. Thus, the RF source may subsequently transmit a frequency hopped, FL CW 1204 at a different frequency. If this hopped frequency happens to have high channel gain, the subsequent FL CW 1204 may result in greater tag Rx power than before.

Moreover, similar to FL data subchannels and FL data subchannel sets, FL CW subchannels and FL CW subchannel sets may be defined for FL CW frequency hopping. More particularly, FL CW may be transmitted in FL CW subchannels and may hop within a configured FL CW subchannel set. By employing frequency hopping in FL CW and defining FL CW subchannels and FL CW subchannel sets, the A-IoT system may adapt to varying channel conditions and provide more efficient communication between the RF source, tags, and other devices in the A-IoT system. This approach takes advantage of the flexibility offered by frequency hopping and the granularity of subchannels and subchannel sets, allowing for improved communication capabilities in different scenarios.

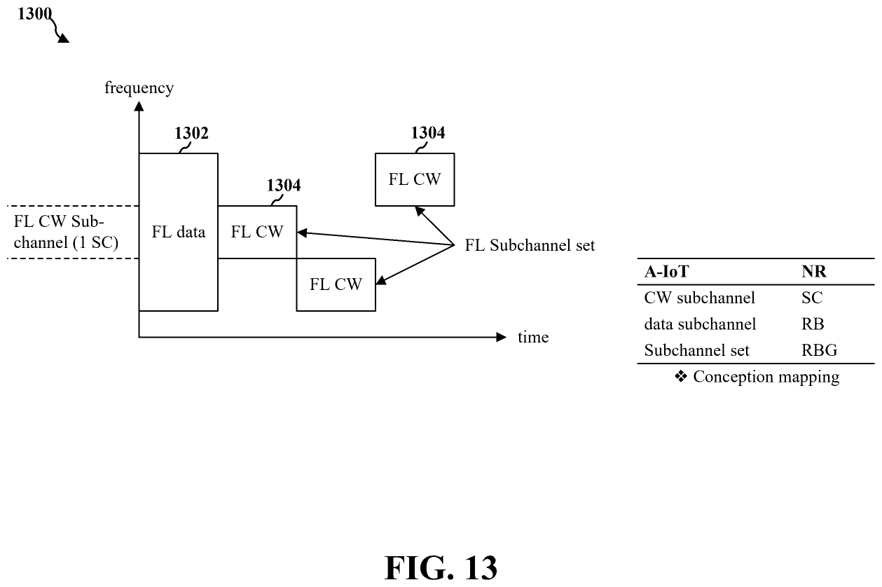

FIG. 13 shows an example of a chart 1300 of frequency over time for FL data 1302 and frequency hopping, FL CW 1304, where the FL CW 1304 frequency hops across different subchannels of a FL CW subchannel set. For instance, in the illustrated example, after transmitting FL data 1302, the RF source may transmit FL CW 1304 initially in one FL CW subchannel of the set, then in another FL CW subchannel of the set, and next in another subchannel of the set, and repeat this frequency hopping pattern similarly over time. In this example, the bandwidth of a FL CW subchannel may span one or more subcarriers, the bandwidth of an FL data subchannel may span one or more RBs, and the bandwidth of an FL data subchannel set may span one or more resource block groups (RBGs).

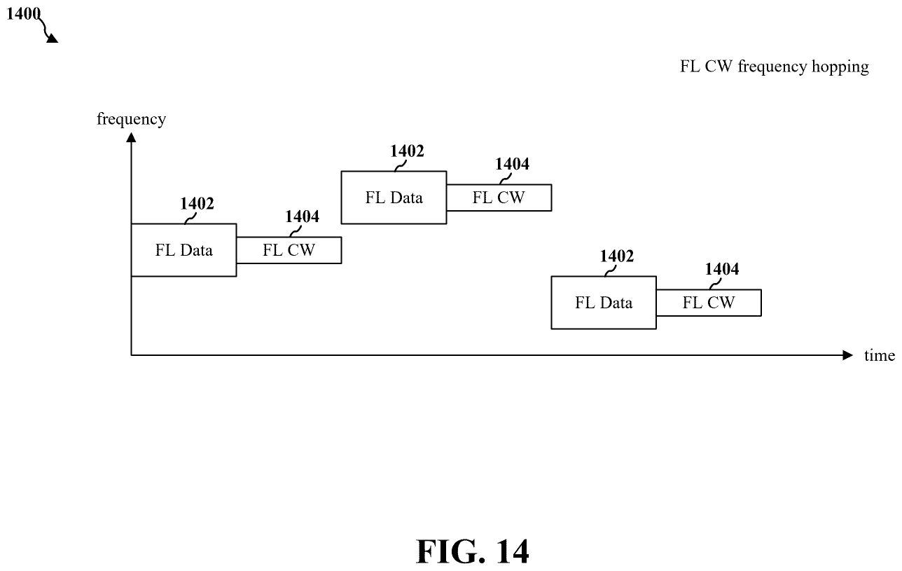

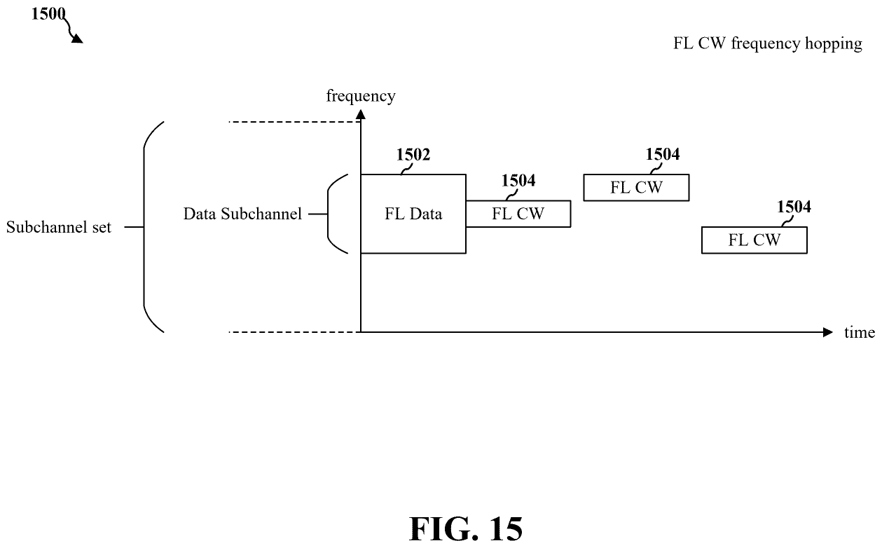

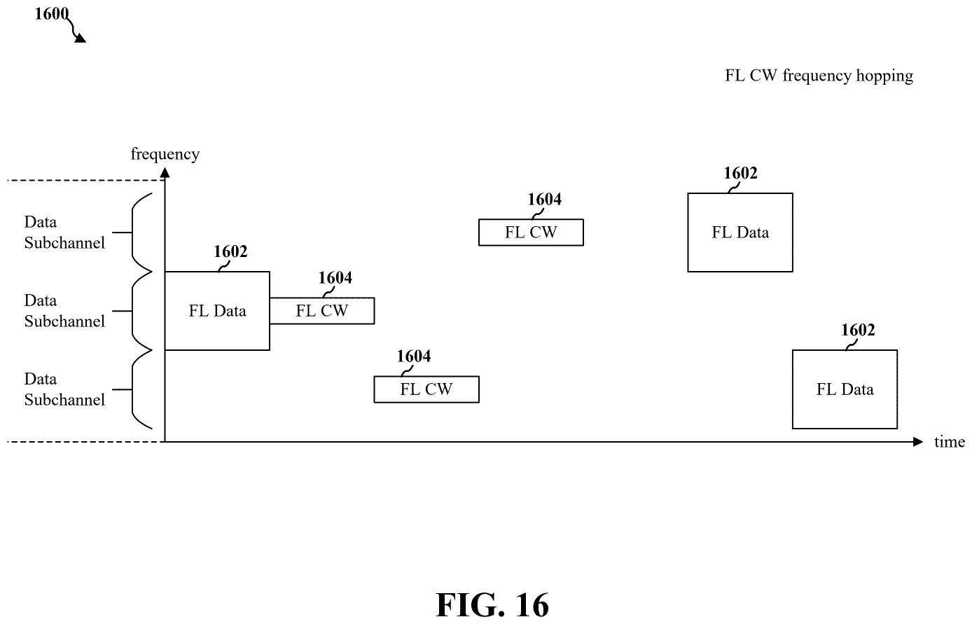

In relation to frequency hopping in FL CW, various configurations may be provided. These configurations may consider the relationship between FL CW subchannels and FL data subchannels in the A-IoT system. In particular, aspects of the present disclosure refer to two main approaches for configuration considering this relationship, and in some cases sub-approaches associated with each main approach. In the first approach, the FL CW frequency may be dependent on the FL data frequency range. In this case, there are two sub-approaches. In the first sub-approach, the FL CW subchannel is located at the center of the FL data subchannel. If FL data frequency hopping is supported, the FL CW frequency hops accordingly. An example of the first sub-approach is illustrated with respect to FIG. 14. In the second sub-approach, the FL CW frequency is located within the range of FL data, and FL CW frequency hopping in the FL data range may be supported. An example of the second sub-approach is illustrated with respect to FIG. 15. Alternatively, in the second approach, the FL CW frequency is independent of the FL data frequency range. An example of the second approach is illustrated with respect to FIG. 16. These approaches and sub-approaches provide different ways to configure the relationship between FL CW subchannels and FL data subchannels in the A-IoT system, allowing for more efficient and flexible communication between the RF source, tags, and other devices in the A-IoT system. By considering these approaches and sub-approaches, the A-IoT system may adapt to varying channel conditions and provide improved communication capabilities in different scenarios.

FIG. 14 shows an example of a chart 1400 of frequency over time for frequency hopping, FL data 1402 and FL CW 1404 in accordance with the first approach and first sub-approach. In this example, the RF source transmits the FL data 1402 in different FL data subchannels according to an FL data frequency hopping pattern, while the FL CWs 1404 following respective FL data transmissions hop to associated center frequencies according to the FL data pattern. Thus, the frequency hopping behavior of the FL CWs 1404 is dependent on the FL hopping behavior of the FL data 1402.

FIG. 15 shows an example of a chart 1500 of frequency over time for FL data 1502 and frequency hopping, FL CW 1504 in accordance with the first approach and second sub-approach. In this example, the RF source transmits the FL CW 1504 in different FL CW subchannels according to an FL CW frequency hopping pattern following transmission of the FL data 1502 within an FL data subchannel of an FL data subchannel set. The FL CWs 1504 may frequency hop to different frequencies within the FL data subchannel associated with the prior FL data transmission. Thus, the frequency hopping behavior of the FL CWs 1504 is dependent on the frequency range of the preceding FL data 1502.

FIG. 16 shows an example of a chart 1600 of frequency over time for frequency hopping, FL data 1602 and frequency hopping, FL CW 1504 in accordance with the second approach. In this example, following transmission of the FL data 1602 within an FL data subchannel of an FL data subchannel set, the RF source transmits the FL CW 1604 in different FL CW subchannels according to an FL CW frequency hopping pattern, similar to the example of FIG. 15. However, in this example, the FL CWs 1604 may frequency hop to different frequencies within any FL CW subchannel of an FL CW subchannel set, regardless of whether the FL CW subchannels are in the FL data subchannel associated with the prior FL data transmission or in other FL data subchannels. For instance, in the illustrated example, following transmission of the FL data 1602 in one FL data subchannel, the FL CW 1604 may frequency hop across the different FL data subchannels. Thus, in this example, the frequency hopping behavior of the FL CWs 1604 is independent of the FL hopping behavior and frequency range of the FL data 1602, in contrast to the previous two examples.

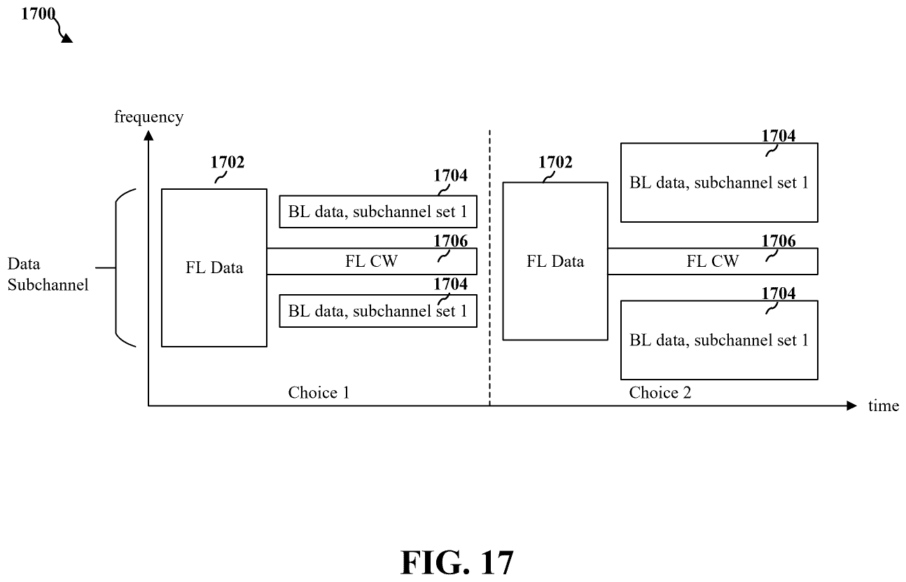

In various aspects of the present disclosure, frequency hopping of BL data may be provided considering the relationship between FL data frequency range and BL data frequency range in the A-IoT system. Similar to FL CW frequency hopping, there are two main approaches to consider regarding this relationship. In the first approach, the FL data frequency range and the BL data frequency range may be the same, providing a consistent frequency range for both FL and BL data. In the second approach, the FL data frequency range and the BL data frequency range may be different, allowing for more flexibility in configuring the frequency ranges. In this context, the FL data subchannel sets and BL subchannel sets may be individually configured. Additionally, in this context, FL CW subchannel sets and BL subchannel sets may be individually configured. An example of both approaches is illustrated with respect to FIG. 17 (on the left for the first approach and on the right for the second approach). These approaches provide different ways to configure the relationship between FL data frequency range and BL data frequency range in the A-IoT system, allowing for more efficient and flexible communication between the RF source, tags, and other devices in the A-IoT system. By considering these approaches, the A-IoT system may adapt to varying channel conditions and provide improved communication capabilities in different scenarios.

FIG. 17 illustrates an example of a chart 1700 showing frequency over time of a transmission of FL data 1702, and BL data 1704 responsive to the FL data and double frequency shifted with respect to an FL CW 1706. The chart depicts different examples in accordance with the first approach and the second approach. In the first approach, after the RF source transmits FL data 1702 in an FL data subchannel, the tag transmits BL data 1704 in a BL data subchannel set. The BL data subchannel set may include frequencies within the same range as the FL data subchannel. In the second approach, the tag likewise transmits BL data 1704 in a BL data subchannel set, but the BL data subchannel set may include frequencies within a different range than that of the FL data subchannel. Thus, in the illustrated example, the BL data 1704 may be transmitted outside the range of the FL data subchannel carrying the FL data 1702.

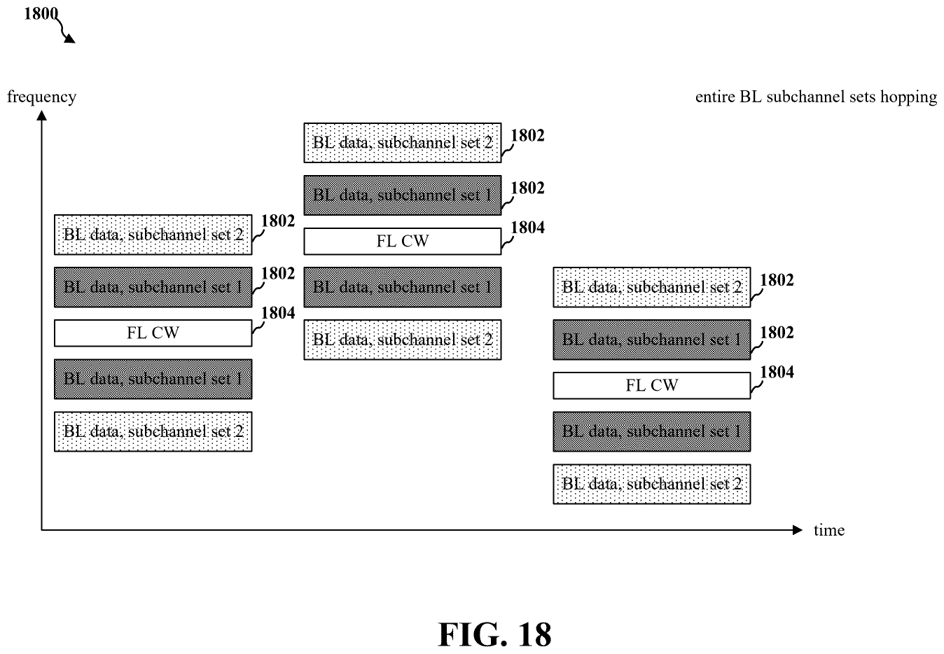

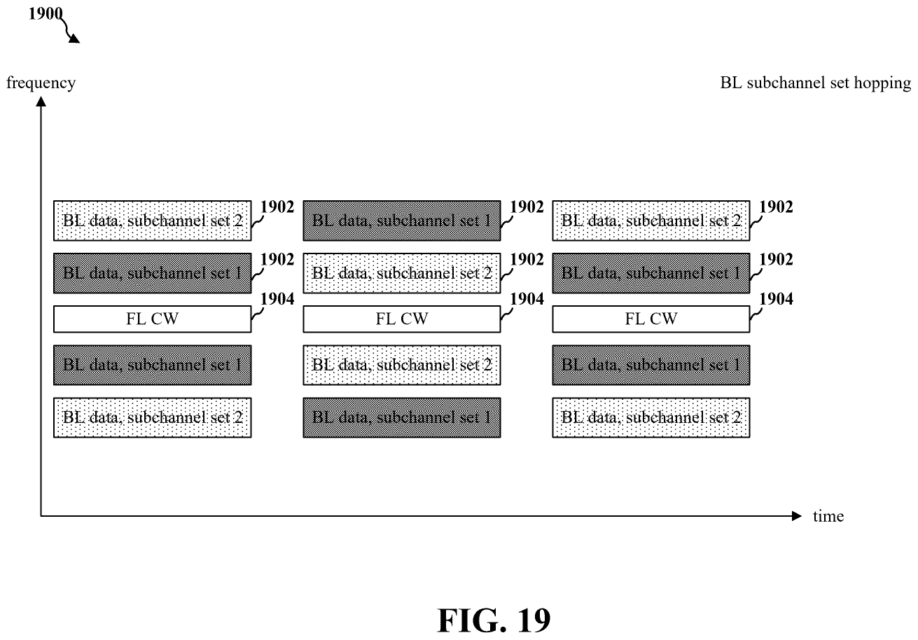

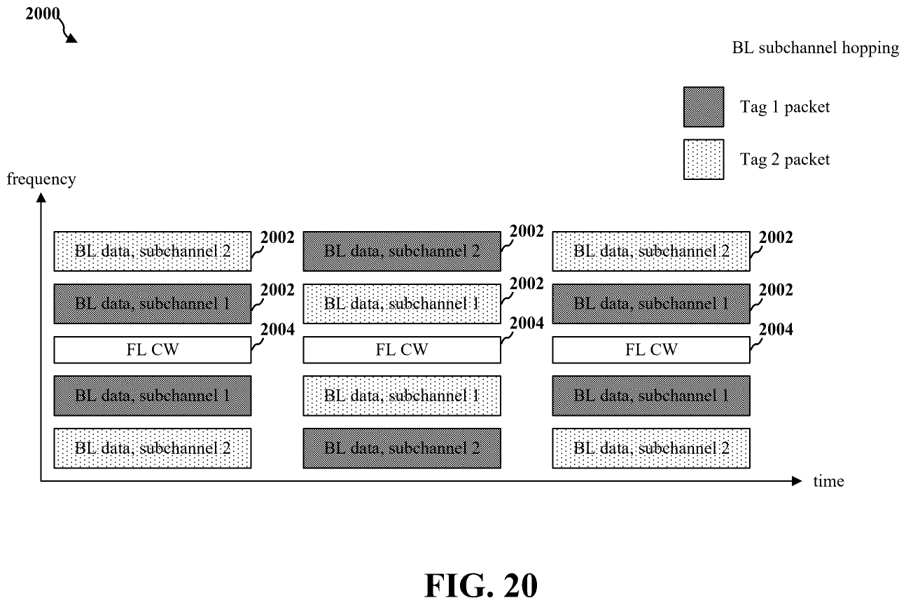

In other aspects of the present disclosure, in relation to BL data frequency hopping in an A-IoT system, various configurations may be provided. There are three main approaches to consider regarding BL data frequency hopping. In the first approach, the entire BL subchannel sets hop, with no hopping compared to FL CW. In this case, the FL CW frequency hop and the BL data subchannel sets adjust frequencies accordingly. An example of the first approach is illustrated with respect to FIG. 18. In the second approach, the BL subchannel sets hop, with hopping compared to FL CW. In this case, one subchannel set may be for passive data for example, while another subchannel set may be for semi-passive data for example. An example of the second approach is illustrated with respect to FIG. 19. In the third approach, the BL subchannels hops with hopping compared to FL CW. In this case, the BL data packets may hop to different BL data subchannels at different frequency shifts with respect to the FL CW. An example of the third approach is illustrated with respect to FIG. 20. These approaches provide different ways to configure the frequency hopping behavior of BL data in the A-IoT system. By exploring these approaches, the A-IoT system may enable more efficient and flexible communication between the RF source, tags, and other devices in the A-IoT system. Furthermore, these approaches allow the A-IoT system to adapt to varying channel conditions and provide improved communication capabilities in different scenarios.

FIG. 18 illustrates a chart 1800 showing frequency over time of BL data 1802 transmitted in double sideband signals in different BL data subchannel sets. The BL data subchannel sets may be respectively configured with different frequency shifts with respect to the center frequency of an FL CW 1804. In this example, when the FL CW 1804 hops over time to different frequencies, the BL data subchannel sets change frequencies with the FL CW 1804. However, the BL data subchannel sets do not hop with respect to the FL CW 1804; the BL data subchannel set frequencies just follow the hopping frequency of the FL CW 1804. Thus, the hopping of the BL data subchannel sets is dependent on the frequency hopping pattern of the FL CW 1804.

FIG. 19 illustrates an example of a chart 1900 showing frequency over time of BL data 1902 transmitted in double sideband signals in different BL data subchannel sets. Similar to the previous example, the BL data subchannel sets may be respectively configured with different frequency shifts with respect to the center frequency of an FL CW 1904. However, unlike the previous example, here the BL data subchannel sets may hop with respect to the FL CW 1904. For instance, in the illustrated example, the BL data subchannel sets may hop over time to different frequencies, or the frequency shifts associated with different BL data subchannel sets may change, with respect to an FL CW transmitted periodically over the same center frequency.

FIG. 20 illustrates an example of a chart 2000 showing frequency over time of BL data 2002 transmitted in double sideband signals in different BL data subchannels of the same or different BL data subchannel sets. For instance, one BL data subchannel may carry BL data from one ambient IoT device such as a tag, while another BL data subchannel may carry BL data from a different ambient IoT device such as a different tag. Here, the BL data subchannels may be respectively configured with different frequency shifts with respect to the center frequency of an FL CW 2004, similar to the BL data subchannel sets in the prior two examples. However, in this example, the BL data subchannels may hop with respect to the FL CW 2004, or the BL data packets may hop to different BL data subchannels at different frequency shifts with respect to the FL CW 2004.

In various aspects of the present disclosure, signaling may be provided in the A-IoT system to configure frequency hopping behavior of FL CW, FL data, or BL data. For instance, in a simple bistatic configuration scenario where the base station acting as RF source communicates with a tag and a UE acting as RF reader, the triggering of FL data or FL CW frequency hopping may be subject to base station implementation. However, the base station regardless of implementation may configure the ambient IoT device to perform frequency hopping in BL, including subchannel set hopping or subchannel hopping. The base station may also configure the reader with information about the FL CW, FL data, or BL data frequency hopping, such as a frequency hopping pattern index which may indicate the specific channels an ambient IoT device may hop between during communication of FL data, FL CW, or BL data. As a result, the reader may ascertain the frequency where the UE may receive BL data signals from the ambient IoT device, achieving more efficient communication between the devices in the A-IoT system than in traditional RFID systems.

Moreover, in a more complex bistatic configuration scenario, a base station may communicate with an ambient IoT device and a UE acting as RF reader through an intermediate UE, where the intermediate UE this time is the device acting as an RF source. In this case, the base station may configure the intermediate UE with FL data, FL CW, or BL data frequency hopping information such as a frequency hopping mode, a frequency hopping pattern, or other parameters such as a subchannel set, subchannel size, subchannel number, start/end frequency, and the like. In one example, a frequency hopping mode for an ambient IoT device may indicate whether the tag performs frequency hopping of BL data, while a frequency hopping pattern for an ambient IoT device may indicate how the tag performs such BL data frequency hopping. For instance, the base station may configure, or the UE acting as RF source may receive a configuration of, a frequency hopping pattern index specifying which channels the tag may hop between. This allows for a more flexible and adaptable communication system in the A-IoT environment by providing granularity in frequency hopping behavior.

In various aspects of the present disclosure, signaling may be provided that indicates a FL or BL subchannel or subchannel set for frequency hopping, a frequency hopping pattern, whether frequency hopping is to be applied for FL data, FL CW, or BL data, or other frequency hopping-related information. In one example, the signaling may indicate whether BL data frequency hopping may be between subchannels and subchannel sets, such as spanning across multiple subchannel sets. In another example, a configured frequency hopping mode or pattern may be indicated as either a FL data frequency hopping mode or pattern, a FL CW frequency hopping mode or pattern, or a BL frequency hopping mode or pattern. In another example, the UE acting as RF source may configure a BL frequency hopping pattern or mode of the ambient IoT device. In a further example, the UE acting as RF source or the base station may provide the RF reader with information regarding a FL CW, FL data, or BL frequency hopping mode or pattern, so that the reader may ascertain where to receive BL signals from a tag. In an additional example, the reader may in some cases be the same device as the UE or base station acting as RF source. In the various example, more efficient and flexible communication between the devices in the A-IoT system may be provided than in a traditional RFID system, since for example, a UE acting as RF source and a reader may adapt their frequency hopping behavior based on information provided from a base station.

In one aspect of the present disclosure, communication may be improved between an RF source, such as a base station or UE, and tags or other ambient IoT devices in an A-IoT system, through use of the same frequency range for FL data transmissions during an initial connection or discovery stage and a data transfer or communication stage for a specific ambient IoT device. There are two approaches that may be considered for implementing this aspect of the disclosure. The first approach involves discovering tags in multiple channels, such as all FL data subchannels, and then performing data transfer with the discovered tags. In this approach, the RF source may discover all tags in different FL data subchannels before initiating data transfer with the tags. The second approach involves discovering tags in a specific channel such as a specific FL data subchannel and then performing data transfer for those tags in that specific channel. In this approach, the RF source discovers tags in a specific FL data subchannel and immediately initiates data transfer with the discovered tags within the same subchannel before moving on to the next subchannel for discovery and data transfer. Both approaches apply FL data frequency hopping to enhance communication efficiency and reliability.

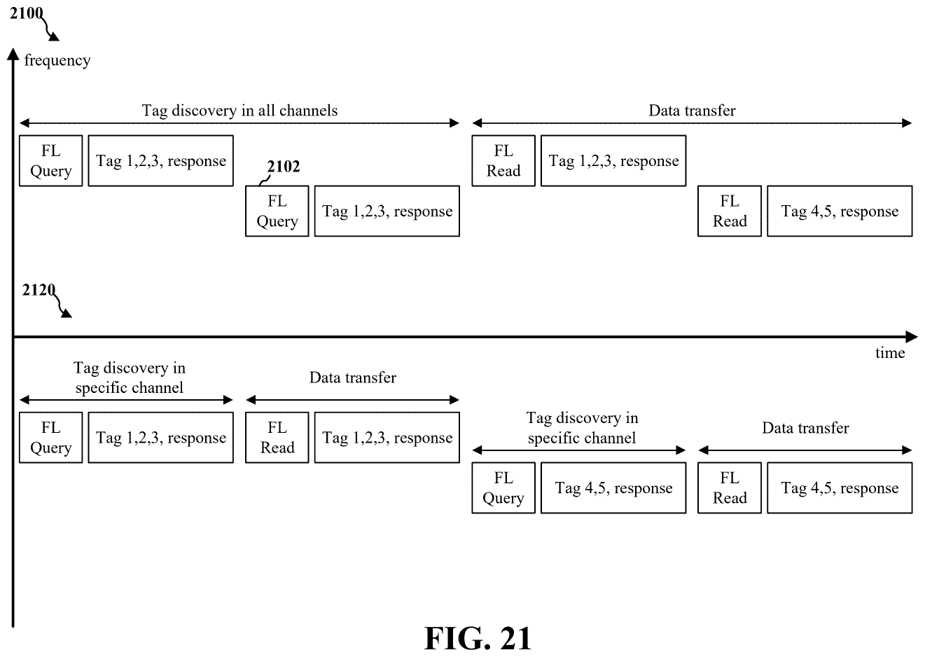

FIG. 21 illustrates an example depicting the first approach and the second approach. In an example 2100 of the first approach, the RF source initially transmits an FL query 2102 in one FL data subchannel, discovering certain tags 1, 2, and 3. The RF source then frequency hops to another FL data subchannel and discovers other tags 4 and 5. After discovering all the tags, the RF source initiates data transfer with the tags in the corresponding FL data subchannels using the same order as performed during discovery. Alternatively, in an example 2120 of the second approach, the RF source initially transmits FL query 2102 in one FL data subchannel, discovering the tags 1, 2, and 3 similar to the previous example, but here immediately initiates data transfer with the discovered tags within the same subchannel. After completing data transfer with these tags, the RF source then frequency hops to another FL data subchannel and then discovers the tags 4 and 5. Data transfer with these tags then follows within the same subchannel.

Comparing both implementations, in the first approach, frequency hopping occurs a greater number of times during both tag discovery and data transfer, while in the second approach, frequency hopping occurs a lesser number of times due to occurring just between data transfer and tag discovery. Thus, the first implementation may potentially be beneficial in scenarios where it would be useful to identify and establish connections with all available tags in the environment before initiating data transfer, ensuring that no tags are missed during the discovery process. On the other hand, the second approach may be more efficient since it allows for faster communication with the discovered tags within the same subchannel, ensuring better communication quality. The RF source may also maintain the same frequency for discovery and data transfer, which is advantageous because changing the frequency for data transfer may result in poorer communication quality. Although frequency hopping still occurs when switching between different tags in both approaches, the timing of the readings in the second approach may be more efficient, leading to faster communication with the tags.

In another aspect of the present disclosure, ambient IoT devices such as tags may be configured with multiple reception bands. In this aspect, at least one of the FL data or the FL CW may be configured to frequency hop among those bands. It should be understood that this aspect refers to multiple distinct reception bands for the ambient IoT device, rather than multiple sub-bands within a single reception band of the ambient IoT device. For example, referring to the example of FIG. 8, a tag may have two different 20 MHz reception bands (or other bandwidth quantity) configured for the ambient IoT device in which the tag may receive FL data or FL CWs, rather than a single Rx BW as illustrated. This allows for more flexibility in communication and enhances the performance of the A-IoT system.

In one example incorporating this aspect, frequency hopping may be extended from a single reception band to multiple reception bands for the ambient IoT device. Thus, the related signaling and configuration and other aspects previously described with respect to a single reception band, such as frequency hopping pattern indices and subchannel sets, may be adjusted accordingly to accommodate the multiple reception bands. For instance, frequency hopping pattern indices may be extended to cover multiple reception bands, and the FL data and FL CW subchannel sets and subchannels may be configured separately with different indices for each reception band. The configuration of different indices for different reception bands and different subchannel sets per reception band allows for more versatile and efficient communication in the A-IoT system.

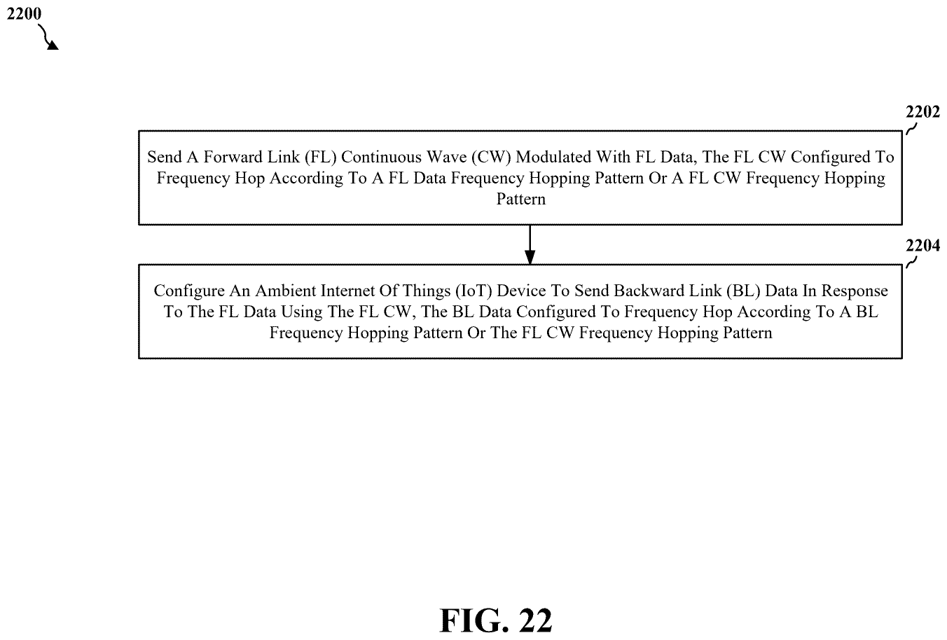

FIG. 22 is a flowchart 2200 of an example method or process for wireless communication performable at a RF source. The method may be performed by a base station or a UE acting as RF source, such as the base station 102/180, disaggregated base station 181, UE 104, wireless device 310, the apparatus 2502, or its components as described herein.

At block 2202, the RF source sends forward link (FL) continuous wave (CW) modulated with FL data. For example, block 2202 may be performed by FL CW frequency hop component 2540. For instance, referring to the Figures, RF source 805, 906 transmits FL CW 804, 904 modulated with FL data 802, 902 to tag 806, 910, such as illustrated in FIG. 4A, either directly to tag 806, 910 such as illustrated in FIG. 4B, or via a relaying UE such as illustrated in FIG. 4C. The FL data may be transmitted using a multi-subcarrier waveform, while the FL CW may be transmitted using a single-subcarrier waveform, such as illustrated and described with respect to FIG. 6. The RF source 805, 906 may be the same device as the RF reader in a monostatic configuration, such as illustrated in FIGS. 5A and 5B, or the RF source and RF reader may be different devices in a bistatic configuration, such as illustrated in FIG. 5C.

The FL CW is configured to frequency hop according to a FL data frequency hopping pattern or a FL CW frequency hopping pattern. For instance, in the example of FIG. 8, the FL CW 804 frequency hops according to a FL data frequency hopping pattern of FL data 802, while in the example of FIG. 9, the FL CW 904 frequency hops according to a FL CW frequency hopping pattern independently of the FL data 902 center frequency. Examples of FL data frequency hopping patterns according to which the FL CW may hop are depicted in FIGS. 8, 10, 11, 14, 16, and 21, while examples of FL CW frequency hopping patterns are depicted in FIGS. 9, 12, 13, 15, and 16. The RF source (such as a base station) may configure the FL CW to frequency hop, or the RF source (such as a UE) may receive from a base station a configuration of the FL CW to frequency hop. This configuration may include, for example, FL CW frequency hopping information or FL data frequency hopping information, such as a frequency hopping index indicating the specific subchannels of one or more subchannel sets between which the FL CW or FL data may hop during communication, a frequency hopping mode indicating whether FL CW frequency hopping or FL data frequency hopping is enabled, or other related parameters such as subchannel set(s), subchannel size, subchannel number, subchannel start and end frequency, and the like.

At block 2204, the RF source configures an ambient Internet of Things (IoT) device to send backward link (BL) data in response to the FL data using the FL CW. For example, block 2204 may be performed by BL frequency hop component 2542. For instance, referring to the Figures, the RF source may transmit a configuration to tag 806, 910 indicating the tag to transmit BL data 808, 908 in response to FL data 802, 902 using FL CW 804, 904 according to a frequency hopping pattern. The configuration may include, for example, FL CW frequency hopping information or BL frequency hopping information, such as a frequency hopping index indicating the specific subchannels of one or more subchannel sets between which the FL CW or BL data may hop during communication, a frequency hopping mode indicating whether FL CW frequency hopping or BL data frequency hopping is enabled, or other related parameters such as subchannel set(s), subchannel size, subchannel number, subchannel start and end frequency, and the like. Following reception of the configuration, the tag 806, 910 transmits BL data 808, 908 in response to the FL data 802, 902 from the RF source 805, 906 using the FL CW 804, 904, such as illustrated in FIG. 4A, either directly to an RF reader such as a UE or base station as illustrated in FIG. 4B, or via a relaying UE such as illustrated in FIG. 4C. The tag 806, 910 may reflect the FL CW 804, 904 as a backscattered signal modulated with its BL data 808, 908 to the RF reader, for example when the tag is a passive or semi-passive ambient IoT device, or the tag may generate and transmit an FL CW modulated with the BL data, for example when the tag is an active ambient IoT device. The tag may also transmit the BL data 808, 908 in a double sideband signal, or at a double frequency shift with respect to the center frequency of the FL data or FL CW, such as illustrated in FIGS. 6 and 7.

The BL data is configured to frequency hop according to a BL frequency hopping pattern or the FL CW frequency hopping pattern. For instance, in the example of FIG. 8, the BL data 808 frequency hops over the BL according to a BL frequency hopping pattern, with retransmissions of the BL data 808 being double frequency shifted with respect to the FL CW 804 at a different frequency within the bandwidth of the FL data 802. In the example of FIG. 9, the BL data 908 and its retransmissions are dependent on the center frequency of the FL CW 904 and frequency hop according to a FL CW frequency hopping pattern, with the tag 910 sending BL data 908 and BL data retransmissions at double frequency shifts with respect to the FL CW(s) 904. Examples of BL frequency hopping patterns are depicted in FIGS. 8, 19, and 20, while examples of FL CW frequency hopping patterns according to which the BL data may hop are depicted in FIG. 9, and 18.

In one example, the BL frequency hopping pattern, the FL data frequency hopping pattern, and the FL CW frequency hopping pattern may be defined frequency hopping patterns respectively associated with a frequency hopping pattern index. For instance, referring to FIG. 10, a first frequency hopping pattern for FL data 1002 may be defined with index ‘1’ based on which the FL data 1002 may frequency hop between subchannels 1 and 3 over time, and a second frequency hopping pattern for FL data 1002 may be defined with index ‘2’ based on which the FL data 1002 may frequency hop between subchannels 2, 1, and 3 over time. Similarly, different frequency hopping patterns and associated indices may be defined for FL CW and BL data in the A-IoT system.

In one example, the RF source sends the FL data in one of a plurality of FL data subchannels of a FL data subchannel set and configures the FL data to frequency hop within the FL data subchannel set according to the FL data frequency hopping pattern. For instance, referring to FIG. 10, the RF source transmits FL data 1002 within respective subchannels of the FL data subchannel set 1012 according to a given frequency hopping pattern, such as hopping between subchannels 1 and 3 over time following the first frequency hopping pattern, or hopping in the order of subchannels 2, 1, and 3 over time following the second frequency hopping pattern. Different frequency hopping patterns may be configured in other examples.

In one example, at least one of the FL data, the FL CW, or the BL data is configured to frequency hop in response to a trigger event. The trigger event may include an initial access stage for discovery of ambient IoT devices, such as illustrated in FIGS. 11 and 21, where the RF source transmits FL queries 1102, 2102 in different FL data subchannels to discover tags. Another trigger event may be a missed acknowledgment or a negative acknowledgment of the FL data or the BL data, such as depicted in FIG. 8, where the RF source 805 retransmits FL data 802 and FL CW 804 at a different frequency if the RF reader 810 does not receive the BL data 808 or its retransmissions from the tag 806. The trigger event may also involve a configuration of blind retransmissions for the FL data, which may include retransmitting the FL data without receiving an acknowledgment or negative acknowledgment from the tag. Additionally, the trigger event may be a received power of the FL data or the BL data being below a threshold, which may indicate poor channel conditions and necessitate frequency hopping to improve communication quality. In response to these trigger events, the FL data, FL CW, or BL data may frequency hop to different frequencies or subchannels to improve communication efficiency and reliability in the A-IoT system.

In one example, the RF source sends the FL CW in one of a plurality of FL CW subchannels of a FL CW subchannel set and configures the FL CW to frequency hop within the FL CW subchannel set according to the FL CW frequency hopping pattern. For instance, referring to FIG. 13, the RF source 1306 transmits the FL CW 1304 in different FL CW subchannels within the FL CW subchannel set according to a FL CW frequency hopping pattern. The RF source may configure the FL CW frequency hopping for example by defining the FL CW frequency hopping pattern, specifying the sequence of FL CW subchannels to be used, and setting the timing for the frequency hops. In the example of FIG. 13, the FL CW 1304 frequency hops between different FL CW subchannels within the FL CW subchannel set over time according to the FL CW frequency hopping pattern.

In one example, the FL CW is configured to frequency hop to center frequencies of respective FL data subchannels according to the FL data frequency hopping pattern. Referring to FIG. 14, particularly the first sub-approach, the RF source 1306 transmits the FL data 1302 and then the FL CW 1304, with the FL CW center frequency being located at the center of the FL data subchannel. If the FL data frequency hopping is supported, the FL CW frequency hops accordingly, following the same frequency hopping pattern as the FL data. This configuration allows for efficient communication between the RF source 1306, tags, and other devices in the A-IoT system, as the FL CW frequency hopping behavior is dependent on the FL data frequency hopping behavior, providing consistent and synchronized communication between the devices.

In one example, the FL CW is configured to frequency hop within an FL data subchannel according to the FL CW frequency hopping pattern based on the FL data frequency hopping pattern. Referring to FIG. 15, particularly the second sub-approach, the RF source transmits the FL data 1502 and then the FL CW 1504. The FL CW 1504 is located within the range of the FL data 1502 and frequency hops within the FL data subchannel according to the FL CW frequency hopping pattern. This configuration allows for efficient communication between the RF source, tags, and other devices in the A-IoT system, as the FL CW frequency hopping behavior is dependent on the frequency range of the preceding FL data 1502, providing consistent and synchronized communication between the devices.

In one example, the FL CW is configured to frequency hop to different FL data subchannels according to the FL CW frequency hopping pattern independently of the FL data frequency hopping pattern. Referring to FIG. 16, the RF source transmits the FL data 1602 and then the FL CW 1604. The FL CW 1604 frequency hops between different FL data subchannels according to the FL CW frequency hopping pattern, independently of the FL data frequency hopping pattern. This configuration allows for efficient communication between the RF source, tags, and other devices in the A-IoT system, as the FL CW frequency hopping behavior is independent of the FL data frequency hopping behavior, providing flexibility in communication between the devices.

In one example, the RF source sends the FL data in a FL data subchannel set and sends the FL CW in a FL CW subchannel set, while the BL data is configured to be sent in a BL data subchannel set. For instance, referring to FIG. 17, the RF source transmits the FL data 1702 in a FL data subchannel set and the FL CW 1706 in a FL CW subchannel set. Examples of FL data subchannel sets and FL CW subchannel sets may be seen in FIGS. 10, 11, 14, and 15. The tag sends the BL data 1708 in a BL data subchannel set. To configure the BL data to be sent in a BL data subchannel set, the RF source may transmit a configuration message to the tag, specifying the BL data subchannel set and associated parameters, such as subchannel size, subchannel number, start and end frequency, and frequency hopping pattern. Upon receiving the configuration message, the tag may transmit the BL data in the specified BL data subchannel set according to the provided parameters, ensuring efficient and flexible communication between the RF source, the tag, and other devices in the A-IoT system. The FL data subchannel set, the FL CW subchannel set, and the BL data subchannel set may be individually configured subchannel sets, allowing for efficient allocation of frequency resources and communication between the RF source, the tag, and other devices in the A-IoT system. This configuration provides flexibility in managing the frequency resources for FL data, FL CW, and BL data, enabling improved communication capabilities in different scenarios.

In one example, the BL data subchannel set is contained within an FL data subchannel of the FL data subchannel set, sharing the same frequency range. Referring to FIG. 17, the RF source transmits the FL data 1702 in a FL data subchannel of the FL data subchannel set and the FL CW 1706 in a FL CW subchannel set. The tag sends the BL data 1704 in a BL data subchannel set. In this example, the BL data subchannel set is contained within the FL data subchannel of the FL data subchannel set, utilizing the same frequency range for both FL data and BL data. This configuration allows for efficient communication between the RF source, the tag, and other devices in the A-IoT system, as the BL data subchannel set is aligned with the FL data subchannel, enabling improved communication capabilities in different scenarios.

In one example, the BL data subchannel set extends outside an FL data subchannel of the FL data subchannel set, using a different frequency range. Referring to FIG. 17, the RF source transmits the FL data 1702 in a FL data subchannel of the FL data subchannel set and the FL CW 1706 in a FL CW subchannel set. The tag sends the BL data 1704 in a BL data subchannel set. In this example, the BL data subchannel set extends outside the FL data subchannel of the FL data subchannel set, utilizing a different frequency range for the BL data compared to the FL data. This configuration allows for efficient communication between the RF source, the tag, and other devices in the A-IoT system, as the BL data subchannel set is not limited to the FL data subchannel, providing flexibility in managing the frequency resources for BL data and enabling improved communication capabilities in different scenarios.

In one example, the BL data is configured to be sent in one or more BL data subchannel sets, the FL CW is configured to frequency hop according to the FL CW frequency hopping pattern, and the one or more BL data subchannel sets are configured to frequency hop at a same frequency shift with respect to the FL CW. Referring to FIG. 18, particularly the first approach, the RF source transmits the FL data and the FL CW 1804, with the FL CW 1804 frequency hopping according to a FL CW frequency hopping pattern. The FL CW frequency hopping pattern may be a predefined sequence or pattern of frequency changes for the FL CW during communication, dictating how the FL CW changes its frequency over time, allowing the RF source to adapt to varying channel conditions and improve communication with the tag, such as illustrated in the example of FIG. 18. The tag sends the BL data 1802 in one or more BL data subchannels within one or multiple BL data subchannel sets, providing flexibility in managing the frequency resources for BL data and allowing for efficient communication between the RF source, the tag, and other devices in the A-IoT system. The multiple BL data subchannels may accommodate different classes of tags with varying frequency shift abilities or support multiple tags transmitting BL data simultaneously, enabling improved communication capabilities in different scenarios. In this example, the one or more BL data subchannels within the BL data subchannel sets frequency hop at the same frequency shift with respect to the FL CW 1804. This configuration allows for efficient communication between the RF source, the tag, and other devices in the A-IoT system, as the BL data subchannels frequency hop in synchronization with the FL CW frequency hopping, enabling improved communication capabilities in different scenarios.

In one example, the BL data is configured to be sent in one or more BL data subchannel sets, and the one or more BL data subchannel sets are configured to frequency hop with respect to the FL CW according to the BL frequency hopping pattern. Referring to FIG. 19, particularly the second approach, the RF source transmits the FL data in a FL data subchannel of the FL data subchannel set and the FL CW 1904 in a FL CW subchannel set. The tag sends the BL data 1902 in one or more BL data subchannels within one or multiple BL data subchannel sets. In this example, the BL data subchannel sets frequency hop with respect to the FL CW 1904 according to the BL frequency hopping pattern, which may be a predefined sequence or pattern of frequency changes for the BL data during communication. This configuration allows for efficient communication between the RF source, the tag, and other devices in the A-IoT system, as the BL data subchannel sets frequency hop independently of the FL CW frequency hopping, providing flexibility in managing the frequency resources for BL data and enabling improved communication capabilities in different scenarios.

In one example, the BL data is configured to be sent in a BL data subchannel, and the BL data is configured to frequency hop with respect to the FL CW to a different BL data subchannel according to the BL frequency hopping pattern. For instance, referring to FIG. 20, particularly the third approach, the RF source transmits the FL data in a FL data subchannel of the FL data subchannel set and the FL CW 2004 in a FL CW subchannel set. The tag sends the BL data 2002 in a BL data subchannel. In this example, the BL data 2008 frequency hops with respect to the FL CW 2004 to a different BL data subchannel according to the BL frequency hopping pattern, which may be a predefined sequence or pattern of frequency changes for the BL data during communication. This configuration allows for efficient communication between the RF source, the tag, and other devices in the A-IoT system, as the BL data frequency hops independently of the FL CW frequency hopping, providing flexibility in managing the frequency resources for BL data and enabling improved communication capabilities in different scenarios.

In one example, the RF source sends, to the ambient IoT device, a configuration of a BL frequency hopping mode for the ambient IoT device. The RF source may be a base station or a UE. The BL frequency hopping mode indicates whether the BL frequency hopping pattern includes BL data subchannel set hopping or BL data subchannel hopping. In this context, the BL frequency hopping pattern provides the tag with information about the specific channels, subchannel set(s), subchannel size, subchannel number, subchannel start and end frequency, and the like, where frequency hopping occurs. In contrast, the BL frequency hopping mode indicates whether frequency hopping in subchannels or subchannel sets is enabled, such as whether FL CW frequency hopping or FL data frequency hopping is enabled. This configuration allows for efficient communication between the RF source, the tag, and other devices in the A-IoT system, as the tag may adapt its frequency hopping behavior based on the information provided by the gNB, enabling improved communication capabilities in different scenarios. In the example of FIG. 19, the tag sends BL data in a BL data subchannel set that hops with respect to the FL CW, illustrating BL data subchannel set hopping. In the example of FIG. 20, the tag sends BL data in individual BL data subchannels that hop with respect to the FL CW, illustrating BL data subchannel hopping. As described with respect to FIG. 19 and FIG. 20, the RF source (for example the UE) may configure the tag's BL frequency hopping pattern or mode, allowing for efficient communication between the RF source, the tag, and other devices in the A-IoT system, as the UE may adapt its frequency hopping behavior based on the information provided by the base station, enabling improved communication capabilities in different scenarios.

In one example, the RF source sends an FL query during a discovery stage for the ambient IoT device, and sends the FL data during an FL data transfer stage following the discovery stage within the same frequency range as the FL query. Referring to FIG. 21, the RF source transmits an FL query 2102 in a specific FL data subchannel during the initial connection (discovery) stage. After discovering the tag, the RF source initiates the data transfer stage, sending the FL data within the same frequency range as the FL query 2102. This configuration ensures that the same frequency range is used for both the discovery and data transfer stages, enhancing communication efficiency and reliability between the RF source and the tag.

In one example, the RF source sends the FL data after a plurality of FL queries respectively for ambient IoT devices in different FL data subchannels during the discovery stage. Referring to FIG. 21, the RF source first discovers tags in different FL data subchannels by transmitting a series of FL queries 2102. After discovering the tags, the RF source initiates data transfer with the tags in the corresponding FL data subchannels using the same order as performed during discovery. In this implementation, frequency hopping occurs during both tag discovery and data transfer.

In one example, the RF source sends the FL data to the ambient IoT device in a FL data subchannel prior to another FL query for a different ambient IoT device in a different FL data subchannel. Referring to FIG. 21, the RF source discovers tags in a specific FL data subchannel by transmitting an FL query 2102 and immediately initiates data transfer with the discovered tags within the same subchannel before moving on to the next subchannel for discovery and data transfer. In this alternative implementation, frequency hopping occurs between data transfer and tag discovery. This approach allows for faster communication with the discovered tags within the same subchannel, ensuring better communication quality.

In one example, at least one of the FL data or the FL CW is configured to frequency hop between different reception bands configured for the ambient IoT device. For instance, considering the concepts discussed with respect to FIGS. 8 and 9, the RF source 805, 906 may configure the FL data 802, 902 or the FL CW 804, 904 to frequency hop among multiple distinct reception bands for the ambient IoT device (tag 806, 910), rather than subbands within a single reception band of the tag. This configuration may be achieved by the RF source (such as a base station) transmitting a control message or signaling to the ambient IoT device (tag 806, 910) or RF reader to configure the frequency hopping behavior of the FL data or FL CW across multiple reception bands. The control message or signaling may include information about the frequency hopping pattern index, frequency hopping mode, or other related parameters for each reception band, such as subchannel set(s), subchannel size, subchannel number, subchannel start and end frequency, and the like. The RF source 805, 906 may transmit the FL data 802, 902 or the FL CW 804, 904 in one reception band, and then frequency hop to another reception band for subsequent transmissions based on the configured frequency hopping pattern index, frequency hopping mode, or other related parameters for each reception band. This allows for more flexibility in communication and enhances the performance of the A-IoT system by providing the ambient IoT device (tag 806, 910) with the ability to receive signals in different reception bands.

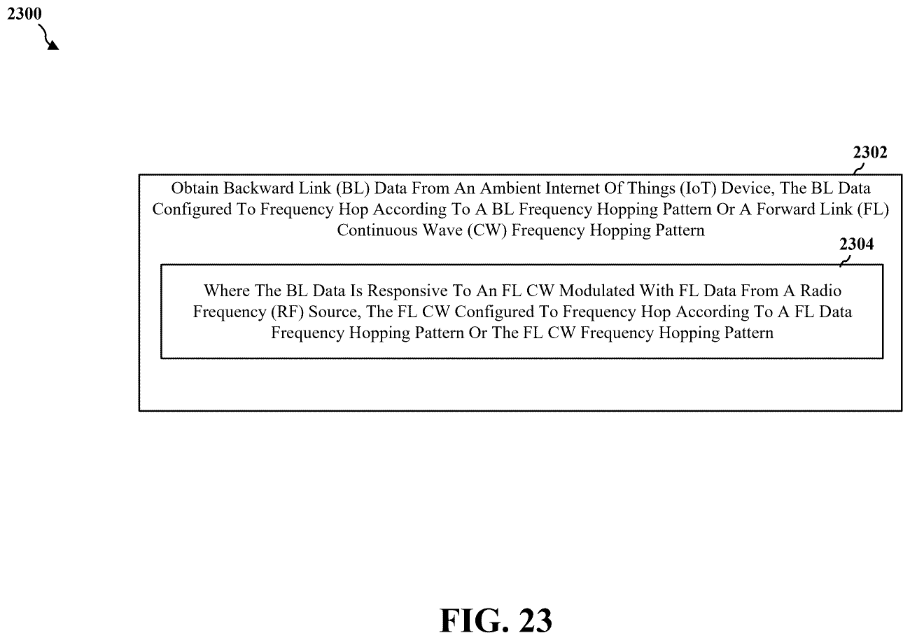

FIG. 23 is a flowchart 2300 of an example method or process for wireless communication performable at a RF reader. The method may be performed by a UE acting as RF reader, such as the UE 104, wireless device 350, the apparatus 2502, or its components as described herein.

At block 2302, the apparatus obtains backward link (BL) data from an ambient Internet of Things (IoT) device. For example, block 2202 may be performed by BL frequency hop component 2542. For instance, referring to the Figures, an RF reader 610, 810, 912 receives BL data 608, 808, 908 from a tag 606, 910. The BL data may be transmitted in response to an FL CW 604, 804, 904 modulated with FL data 602, 802, 902 from an RF source 600, 805, 906, such as illustrated in FIG. 4A, either directly from the tag 606, 910 to the RF reader 610, 810, 912, such as illustrated in FIG. 4B, or via a relaying UE such as illustrated in FIG. 4C. The tag may reflect the FL CW 604, 804, 904 as a backscattered signal modulated with its BL data 608, 808, 908 to the RF reader, for example when the tag is a passive or semi-passive ambient IoT device, or the tag may generate and transmit an FL CW modulated with the BL data, for example when the tag is an active ambient IoT device. The tag may also transmit the BL data 608, 808, 908 in a double sideband signal, or at a double frequency shift with respect to the center frequency of the FL data or FL CW, such as illustrated in FIGS. 6 and 7.

The BL data is configured to frequency hop according to a BL frequency hopping pattern or a forward link (FL) continuous wave (CW) frequency hopping pattern. For instance, in the example of FIG. 8, the BL data 808 frequency hops over the BL according to a BL frequency hopping pattern, with retransmissions of the BL data 808 being double frequency shifted with respect to the FL CW 804 at a different frequency within the bandwidth of the FL data 802. In the example of FIG. 9, the BL data 908 and its retransmissions are dependent on the center frequency of the FL CW 904 and frequency hop according to a FL CW frequency hopping pattern, with the tag 910 sending BL data 908 and BL data retransmissions at double frequency shifts with respect to the FL CW(s) 904. Examples of BL frequency hopping patterns are depicted in FIGS. 8, 19, and 20, while examples of FL CW frequency hopping patterns according to which the BL data may hop are depicted in FIG. 9, and 18.

At block 2304, the BL data is responsive to an FL CW modulated with FL data from a radio frequency (RF) source. For example, block 2304 may be performed by FL CW frequency hop component 2540. For instance, referring to the Figures, the tag 606, 910 receives an FL CW 604, 804, 904 modulated with FL data 602, 802, 902 from an RF source 600, 805, 906, such as illustrated in FIG. 4A, either directly from the RF source 600, 805, 906 to the tag 606, 910, such as illustrated in FIG. 4B, or via a relaying UE such as illustrated in FIG. 4C. In response to the FL CW including modulated data from the RF source, the tag 606, 910 sends BL data 608, 808, 908 to the RF reader 610, 810, 912. The BL data may be transmitted in a double sideband signal, or at a double frequency shift with respect to the center frequency of the FL data or FL CW, such as illustrated in FIGS. 6 and 7.

The FL CW is configured to frequency hop according to a FL data frequency hopping pattern or the FL CW frequency hopping pattern. For instance, in the example of FIG. 8, the FL CW 804 frequency hops according to a FL data frequency hopping pattern of FL data 802, while in the example of FIG. 9, the FL CW 904 frequency hops according to a FL CW frequency hopping pattern independently of the FL data 902 center frequency. Examples of FL data frequency hopping patterns according to which the FL CW may hop are depicted in FIGS. 8, 10, 11, 14, 16, and 21, while examples of FL CW frequency hopping patterns are depicted in FIGS. 9, 12, 13, 15, and 16. The RF source (such as a base station) may configure the FL CW to frequency hop, or the RF source (such as a UE) may receive from a base station a configuration of the FL CW to frequency hop. This configuration may include, for example, FL CW frequency hopping information or FL data frequency hopping information, such as a frequency hopping index indicating the specific subchannels of one or more subchannel sets between which the FL CW or FL data may hop during communication, a frequency hopping mode indicating whether FL CW frequency hopping or FL data frequency hopping is enabled, or other related parameters such as subchannel set(s), subchannel size, subchannel number, subchannel start and end frequency, and the like.

In one example, the RF reader obtains a configuration of a BL frequency hopping mode for the ambient IoT device from a base station, which is the RF source for the FL data and FL CW. For example, referring to the Figures, the RF reader (UE) receives a configuration from the base station (gNB) regarding the BL frequency hopping mode for the ambient IoT device (tag). The BL frequency hopping mode indicates whether the BL frequency hopping pattern includes BL data subchannel set hopping or BL data subchannel hopping. In this context, the BL frequency hopping pattern provides the tag with information about the specific channels, subchannel set(s), subchannel size, subchannel number, subchannel start and end frequency, and the like, where frequency hopping occurs. In contrast, the BL frequency hopping mode indicates whether frequency hopping in subchannels or subchannel sets is enabled, such as whether FL CW frequency hopping or FL data frequency hopping is enabled. This configuration allows for efficient communication between the RF source, the tag, and other devices in the A-IoT system, as the tag may adapt its frequency hopping behavior based on the information provided by the gNB, enabling improved communication capabilities in different scenarios. In the example of FIG. 19, the tag sends BL data in a BL data subchannel set that hops with respect to the FL CW, illustrating BL data subchannel set hopping. In the example of FIG. 20, the tag sends BL data in individual BL data subchannels that hop with respect to the FL CW, illustrating BL data subchannel hopping. As described with respect to FIG. 19 and FIG. 20, the RF source (for example the UE) may configure the tag's BL frequency hopping pattern or mode, allowing for efficient communication between the RF source, the tag, and other devices in the A-IoT system, as the UE may adapt its frequency hopping behavior based on the information provided by the base station, enabling improved communication capabilities in different scenarios.

In one example, the RF reader obtains a configuration for FL data frequency hopping or FL CW frequency hopping in a subchannel. Referring to the Figures, the RF reader (UE) receives a configuration from the base station (gNB) regarding the FL data frequency hopping or FL CW frequency hopping in a subchannel for communication with the ambient IoT device (tag) or RF source. The configuration may include information such as the subchannel set, subchannel size, subchannel number, and subchannel start frequency or subchannel end frequency for FL data or FL CW. By obtaining this configuration, the RF reader may adapt its frequency hopping behavior based on the information provided by the base station, enabling more efficient and flexible communication in the A-IoT system. This allows the RF source, the tag, and other devices in the A-IoT system to adapt to varying channel conditions and provide improved communication capabilities in different scenarios.

In one example, the RF reader obtains a configuration of an FL data frequency hopping mode or pattern, an FL CW frequency hopping mode or pattern, or a BL frequency hopping mode or pattern for the RF source or the ambient IoT device. The RF reader (UE) receives a configuration from the base station (gNB) regarding the frequency hopping mode or pattern for communication with the ambient IoT device (tag) or RF source. In the FL data frequency hopping mode, the FL data is configured to frequency hop according to a predefined pattern during communication with the tag. In the FL CW frequency hopping mode, the FL CW is configured to frequency hop according to a predefined pattern during communication with the tag. In the BL frequency hopping mode, the tag's BL data is configured to frequency hop according to a predefined pattern during communication with the RF source. The frequency hopping mode indicates whether frequency hopping in subchannels or subchannel sets is enabled, such as whether FL CW frequency hopping or FL data frequency hopping is enabled. In contrast, the frequency hopping pattern provides the tag with information about the specific channels, subchannel set(s), subchannel size, subchannel number, subchannel start and end frequency, and the like, where frequency hopping occurs. By obtaining this configuration, the apparatus may adapt its frequency hopping behavior based on the information provided by the base station, enabling more efficient and flexible communication in the A-IoT system. This allows the RF source, the tag, and other devices in the A-IoT system to adapt to varying channel conditions and provide improved communication capabilities in different scenarios.

In one example, the RF reader obtains, from a base station or a user equipment (UE), a configuration of a BL frequency hopping mode for the ambient IoT device. In this example, the apparatus or RF reader itself acts as the RF source for the FL data and FL CW. The RF reader receives a configuration from the base station or the UE regarding the BL frequency hopping mode for communication with the ambient IoT device (tag). The configuration of a BL frequency hopping mode includes information that specifies how the ambient IoT device (tag) should perform frequency hopping during communication on the backward link (BL). This may involve details such as whether the BL frequency hopping pattern includes BL data subchannel set hopping or BL data subchannel hopping, the specific channels or subchannels to be used, the order in which they should be used, and any other relevant parameters for frequency hopping. By obtaining this configuration, the apparatus may adapt its frequency hopping behavior based on the information provided by the base station or the UE, enabling more efficient and flexible communication in the A-IoT system. This allows the RF source, the tag, and other devices in the A-IoT system to adapt to varying channel conditions and provide improved communication capabilities in different scenarios. As a result, the RF reader knows where to receive the tag BL signals, ensuring efficient communication between the devices in the A-IoT system.

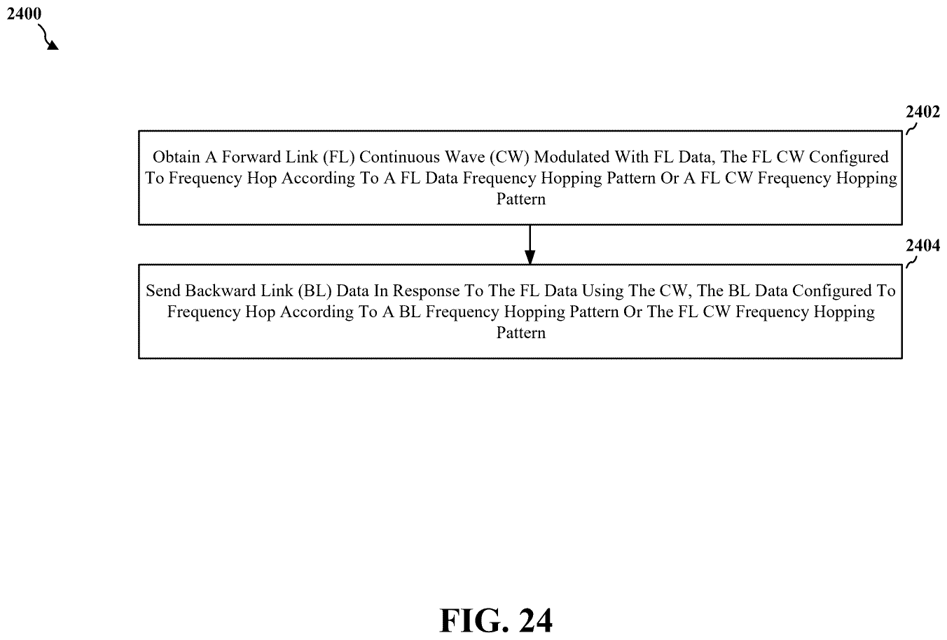

FIG. 24 is a flowchart 2400 of an example method or process for wireless communication performable at an ambient IoT device. The method may be performed by a UE acting as an ambient IoT device, such as the UE 104, wireless device 310, 350, the apparatus 2502, or its components as described herein.

At block 2402, the ambient IoT device obtains a forward link (FL) continuous wave (CW) modulated with FL data. For example, block 2402 may be performed by FL CW frequency hop component 2540. For instance, referring to the Figures, the tag 806, 910 receives FL CW 804, 904 modulated with FL data 802, 902 from the RF source 805, 906, such as illustrated in FIG. 4A, either directly from the RF source 805, 906, such as illustrated in FIG. 4B, or via a relaying UE such as illustrated in FIG. 4C. The FL data may be transmitted using a multi-subcarrier waveform, while the FL CW may be transmitted using a single-subcarrier waveform, such as illustrated and described with respect to FIG. 6.

The FL CW is configured to frequency hop according to a FL data frequency hopping pattern or a FL CW frequency hopping pattern. Examples of FL data frequency hopping patterns according to which the FL CW may hop are depicted in FIGS. 8, 10, 11, 14, 16, and 21, while examples of FL CW frequency hopping patterns are depicted in FIGS. 9, 12, 13, 15, and 16.

At block 2404, the ambient IoT device sends backward link (BL) data in response to the FL data using the CW. For example, block 2404 may be performed by BL frequency hop component 2542. For instance, referring to the Figures, in response to the FL data 802, 902, the tag 806, 910 sends BL data 808, 908 to the RF reader, such as illustrated in FIG. 4A, either directly to an RF reader such as a UE or base station as illustrated in FIG. 4B, or via a relaying UE such as illustrated in FIG. 4C. The tag may reflect the FL CW 804, 904 as a backscattered signal modulated with its BL data 808, 908 to the RF reader, for example when the tag is a passive or semi-passive ambient IoT device, or the tag may generate and transmit an FL CW modulated with the BL data, for example when the tag is an active ambient IoT device. The tag may also transmit the BL data 808, 908 in a double sideband signal, or at a double frequency shift with respect to the center frequency of the FL data or FL CW, such as illustrated in FIGS. 6 and 7.

The BL data is configured to frequency hop according to a BL frequency hopping pattern or the FL CW frequency hopping pattern. Examples of BL frequency hopping patterns are depicted in FIGS. 8, 19, and 20, while examples of FL CW frequency hopping patterns according to which the BL data may hop are depicted in FIG. 9, and 18.

In one example, the ambient IoT device obtains the FL CW according to the FL data frequency hopping pattern and sends the BL data according to the BL frequency hopping pattern. In such case, the ambient IoT device may obtain a retransmitted FL CW modulated with retransmitted FL data, where the retransmitted FL CW is obtained at a different frequency than the FL CW according to the FL data frequency hopping pattern. The ambient IoT device may also send retransmitted BL data using the retransmitted FL CW according to the BL frequency hopping pattern. For instance, referring to FIG. 8, the ambient IoT device (tag 806) obtains the FL CW 804 according to the FL data frequency hopping pattern of FL data 802. In response to the FL data 802, the tag 806 sends BL data 808 according to a BL frequency hopping pattern. If the RF reader 810 does not receive the BL data 808 or its retransmissions, the RF source 805 may re-transmit the FL data 802 at a different center frequency in an FL data frequency hop, following the FL data frequency hopping pattern. The ambient IoT device (tag 806) then obtains the retransmitted FL CW modulated with the retransmitted FL data at a different frequency than the initial FL CW, in accordance with the FL data frequency hopping pattern. In response to receiving the retransmitted FL data carried by the retransmitted FL CW, the ambient IoT device (tag 806) sends retransmitted BL data using the retransmitted FL CW. The retransmitted BL data is sent according to the BL frequency hopping pattern, or a predefined sequence of frequencies for the BL data transmissions such as illustrated in FIG. 8, in response to the retransmitted FL data. This allows the ambient IoT device to adapt its BL data transmissions based on the retransmitted FL data and the associated retransmitted FL CW frequency.

In one example, the ambient IoT device obtains the FL CW and sends the BL data according to the FL CW frequency hopping pattern. In such case, the ambient IoT device may obtain a retransmitted FL CW, where the retransmitted FL CW is obtained at a different frequency than the FL CW according to the FL CW frequency hopping pattern. The ambient IoT device may also send retransmitted BL data using the retransmitted FL CW according to the FL CW frequency hopping pattern. For instance, referring to FIG. 9, the ambient IoT device (tag 910) obtains the FL CW 904 according to the FL CW frequency hopping pattern, which is independent of the FL data 902 center frequency. In response to the FL data 902, the tag 910 sends BL data 908 according to the FL CW frequency hopping pattern. If the RF reader 912 does not receive the BL data 908 or its retransmissions, the RF source 906 may re-transmit the FL CW at a different frequency according to the FL CW frequency hopping pattern. The ambient IoT device (tag 910) then obtains the retransmitted FL CW at a different frequency than the initial FL CW, in accordance with the FL CW frequency hopping pattern. In response to receiving the retransmitted FL CW, the ambient IoT device (tag 910) sends retransmitted BL data using the retransmitted FL CW. The retransmitted BL data is sent according to the FL CW frequency hopping pattern, or a predefined sequence of frequencies for the BL data transmissions such as illustrated in FIG. 9, in response to the retransmitted FL CW. This allows the ambient IoT device to adapt its BL data transmissions based on the retransmitted FL CW frequency.

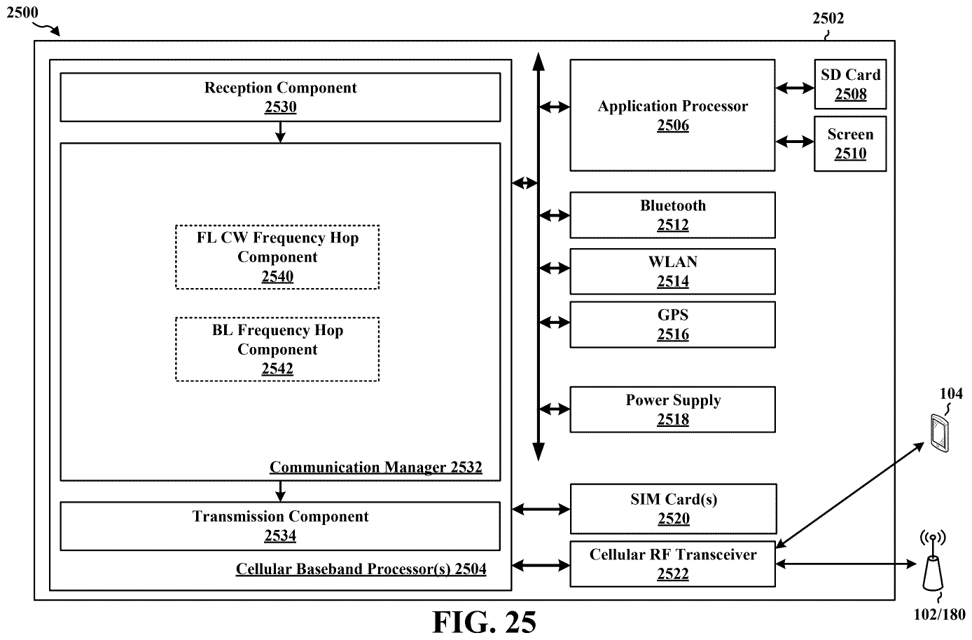

FIG. 25 is a diagram 2500 illustrating an example of a hardware implementation for an apparatus 2502 that acts as an RF source, a RF reader, or an ambient IoT device according to the various aspects of the present disclosure. In one example, the apparatus 2502 may be a UE such as UE 104 and includes one or more cellular baseband processors 2504 (also referred to as a modem) coupled to a cellular RF transceiver 2522 and one or more subscriber identity modules (SIM) cards 2520, an application processor 2506 coupled to a secure digital (SD) card 2508 and a screen 2525, a Bluetooth module 2512, a wireless local area network (WLAN) module 2514, a Global Positioning System (GPS) module 2516, and a power supply 2518. The one or more cellular baseband processors 2504 communicate through the cellular RF transceiver 2522 with the UE 254 and/or BS 252. In another example, the apparatus 2502 may be a base station such as base station 102/180 or one or more components of disaggregated base station 181, in which case the one or more cellular baseband processors 2504 may be replaced by baseband unit(s) (not shown), and in which case one or more illustrated components of FIG. 25 coupled to the baseband unit(s) may be omitted.

The one or more cellular baseband processors 2504 or baseband units may each include a computer-readable medium/one or more memories. The computer-readable medium/one or more memories may be non-transitory. The one or more cellular baseband processors 2504 or baseband units are responsible for general processing, including the execution of software stored on the computer-readable medium/one or more memories individually or in combination. The software, when executed by the one or more cellular baseband processors 2504 or baseband units, causes the one or more cellular baseband processors 2504 or baseband units to, individually or in combination, perform the various functions described supra. The computer-readable medium/one or more memories may also be used individually or in combination for storing data that is manipulated by the one or more cellular baseband processors 2504 or baseband units when executing software. The one or more cellular baseband processors 2504 or baseband units individually or in combination further include a reception component 2530, a communication manager 2532, and a transmission component 2534. The communication manager 2532 includes the one or more illustrated components. The components within the communication manager 2532 may be stored in the computer-readable medium/one or more memories and/or configured as hardware within the one or more cellular baseband processors 2504 or baseband units. The one or more cellular baseband processors 2504 or baseband units may be components of the UE 104, base station 102/180, disaggregated base station 181, or wireless device 310, 350, and may individually or in combination include the one or more memories 360, 376 and/or at least one of the one or more TX processors 316, 368, at least one of the one or more RX processors 356, 370 and at least one of the one or more controllers/processors 359, 375. In one configuration, the apparatus 2502 may be a modem chip and include just the one or more baseband processors 2504, and in another configuration, the apparatus 2502 may be the entire UE (e.g., wireless device 310 or 350 of FIG. 3) and include the aforediscussed additional modules of the apparatus 2502. In another configuration, the apparatus 2502 may include just the baseband units, and in another configuration, the apparatus 2502 may be the entire base station (e.g., wireless device 310 of FIG. 3) and include the aforediscussed additional modules of the apparatus 2502.

The communication manager 2532 includes a FL CW frequency hop component 2540 that is configured to send a FL CW modulated with FL data, with the FL CW configured to frequency hop according to a FL data frequency hopping pattern or a FL CW frequency hopping pattern, such as described in connection with block 2202 of FIG. 22, when the apparatus 2502 is an RF source. Alternatively or additionally, the FL CW frequency hop component 2540 may be configured to obtain a FL CW modulated with FL data, with the FL CW configured to frequency hop according to a FL data frequency hopping pattern or a FL CW frequency hopping pattern, such as described in connection with block 2304 of FIG. 23, when the apparatus 2502 is an RF reader. Alternatively or additionally, the FL CW frequency hop component 2540 may be configured to obtain a FL CW modulated with FL data, with the FL CW configured to frequency hop according to a FL data frequency hopping pattern or a FL CW frequency hopping pattern, such as described in connection with block 2402 of FIG. 24, when the apparatus 2502 is an ambient IoT device. The communication manager 2532 further includes a BL frequency hop component 2542 that is configured to configure an ambient IoT device to send BL data in response to the FL data using the FL CW, with the BL data configured to frequency hop according to a BL frequency hopping pattern or the FL CW frequency hopping pattern, such as described in connection with block 2204 of FIG. 22, when the apparatus 2502 is an RF source. Alternatively or additionally, the BL frequency hop component 2542 may be configured to obtain BL data from an ambient IoT device, with the BL data configured to frequency hop according to a BL frequency hopping pattern or a FL CW frequency hopping pattern, such as described in connection with block 2302 of FIG. 23, when the apparatus 2502 is an RF reader. Alternatively or additionally, the BL frequency hop component 2542 may be configured to send BL data in response to the FL data using the CW, with the BL data configured to frequency hop according to a BL frequency hopping pattern or the FL CW frequency hopping pattern, such as described in connection with block 2404 of FIG. 24, when the apparatus 2502 is an ambient IoT device.

The apparatus may include additional components that perform each of the blocks of the algorithm in the aforementioned flowcharts of FIGS. 22-24. As such, each block in the aforementioned flowcharts of FIGS. 22-24 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 2502, and in particular the one or more cellular baseband processors 2504 or baseband units, includes means for sending a forward link (FL) continuous wave (CW) modulated with FL data, with the FL CW configured to frequency hop according to a FL data frequency hopping pattern or a FL CW frequency hopping pattern, and means for configuring an ambient Internet of Things (IoT) device to send backward link (BL) data in response to the FL data using the FL CW, with the BL data configured to frequency hop according to a BL frequency hopping pattern or the FL CW frequency hopping pattern.

In one configuration, the apparatus 2502, and in particular the one or more cellular baseband processors 2504 or baseband units, includes means for obtaining backward link (BL) data from an ambient Internet of Things (IoT) device, with the BL data configured to frequency hop according to a BL frequency hopping pattern or a forward link (FL) continuous wave (CW) frequency hopping pattern, wherein the BL data is responsive to an FL CW modulated with FL data from a radio frequency (RF) source, the FL CW configured to frequency hop according to a FL data frequency hopping pattern or the FL CW frequency hopping pattern.

In one configuration, the apparatus 2502, and in particular the one or more cellular baseband processors 2504 or baseband units, includes means for obtaining a forward link (FL) continuous wave (CW) modulated with FL data, the FL CW configured to frequency hop according to a FL data frequency hopping pattern or a FL CW frequency hopping pattern, and means for sending backward link (BL) data in response to the FL data using the CW, the BL data configured to frequency hop according to a BL frequency hopping pattern or the FL CW frequency hopping pattern.

The aforementioned means may be one or more of the aforementioned components of the apparatus 2502 configured to perform the functions recited by the aforementioned means. Moreover, as described supra, the apparatus 2502 may include the one or more TX Processors 316, 368, the one or more RX Processors 356, 370, and the one or more controllers/processors 359, 375. As such, in one configuration, the aforementioned means may be at least one of the one or more TX Processors 316, 368, at least one of the one or more RX Processors 356, 370, or at least one of the one or more controllers/processors 359, 375 individually or in any combination configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, a processor, at least one processor, and/or one or more processors, individually or in combination, configured to perform or operable for performing a plurality of actions (such as the functions described supra) is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

Similarly as used herein, a memory, at least one memory, a computer-readable medium, and/or one or more memories, individually or in combination, configured to store or having stored thereon instructions executable by one or more processors for performing a plurality of actions (such as the functions described supra) is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, a computer-readable medium, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, a second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processors may in combination execute the respective subset of instruction to accomplish performing actions X, Y, and Z. Alternatively, a single processor may execute the instructions stored on a single memory, or distributed across multiple memories, to accomplish performing actions X, Y, and Z.

The following examples are illustrative only and may be combined with aspects of other embodiments or teachings described herein, without limitation.

Clause 1. An apparatus for wireless communication, comprising: one or more memories; and one or more processors each communicatively coupled with at least one of the one or more memories, the one or more processors, individually or in any combination, operable to cause the apparatus to: send a forward link (FL) continuous wave (CW) modulated with FL data, the FL CW configured to frequency hop according to a FL data frequency hopping pattern or a FL CW frequency hopping pattern; and configure an ambient Internet of Things (IoT) device to send backward link (BL) data in response to the FL data using the FL CW, the BL data configured to frequency hop according to a BL frequency hopping pattern or the FL CW frequency hopping pattern.

Clause 2. The apparatus of clause 1, wherein the BL frequency hopping pattern, the FL data frequency hopping pattern, and the FL CW frequency hopping pattern are defined frequency hopping patterns respectively associated with a frequency hopping pattern index.

Clause 3. The apparatus of clauses 1 or 2, wherein the one or more processors, individually or in combination, are operable to cause the apparatus to send the FL data in one of a plurality of FL data subchannels of a FL data subchannel set, and the FL data is configured to frequency hop within the FL data subchannel set according to the FL data frequency hopping pattern.

Clause 4. The apparatus of any of clauses 1 to 3, wherein at least one of the FL data, the FL CW, or the BL data is configured to frequency hop in response to a trigger event, the trigger event including: an initial access stage for discovery of ambient IoT devices, a missed acknowledgment or a negative acknowledgment of the FL data or the BL data, a configuration of blind retransmissions for the FL data, or a received power of the FL data or the BL data being below a threshold.

Clause 5. The apparatus of any of clauses 1 to 4, wherein the one or more processors, individually or in combination, are operable to cause the apparatus to send the FL CW in one of a plurality of FL CW subchannels of a FL CW subchannel set, and the FL CW is configured to frequency hop within the FL CW subchannel set according to the FL CW frequency hopping pattern.

Clause 6. The apparatus of any of clauses 1 to 5, wherein the FL CW is configured to frequency hop to center frequencies of respective FL data subchannels according to the FL data frequency hopping pattern.

Clause 7. The apparatus of any of clauses 1 to 6, wherein the FL CW is configured to frequency hop within an FL data subchannel according to the FL CW frequency hopping pattern based on the FL data frequency hopping pattern.

Clause 8. The apparatus of any of clauses 1 to 7, wherein the FL CW is configured to frequency hop to different FL data subchannels according to the FL CW frequency hopping pattern independently of the FL data frequency hopping pattern.

Clause 9. The apparatus of any of clauses 1 to 8, wherein the one or more processors, individually or in combination, are operable to cause the apparatus to send the FL data in a FL data subchannel set and to send the FL CW in a FL CW subchannel set, the BL data is configured to be sent in a BL data subchannel set, and the FL data subchannel set, the FL CW subchannel set, and the BL data subchannel set are individually configured subchannel sets.

Clause 10. The apparatus of clause 9, wherein the BL data subchannel set is contained within a FL data subchannel of the FL data subchannel set.

Clause 11. The apparatus of clause 9 or 10, wherein the BL data subchannel set extends outside an FL data subchannel of the FL data subchannel set.

Clause 12. The apparatus of any of clauses 1 to 11, wherein the BL data is configured to be sent in one or more BL data subchannel sets, the FL CW is configured to frequency hop according to the FL CW frequency hopping pattern, and the one or more BL data subchannel sets are configured to frequency hop at a same frequency shift with respect to the FL CW.

Clause 13. The apparatus of any of clauses 1 to 12, wherein the BL data is configured to be sent in one or more BL data subchannel sets, and the one or more BL data subchannel sets are configured to frequency hop with respect to the FL CW according to the BL frequency hopping pattern.

Clause 14. The apparatus of any of clauses 1 to 13, wherein the BL data is configured to be sent in a BL data subchannel, and the BL data is configured to frequency hop with respect to the FL CW to a different BL data subchannel according to the BL frequency hopping pattern.

Clause 15. The apparatus of any of clauses 1 to 14, wherein the one or more processors, individually or in combination, are further operable to cause the apparatus to: send, to the ambient IoT device, a configuration of a BL frequency hopping mode for the ambient IoT device, the BL frequency hopping mode indicating whether the BL frequency hopping pattern includes BL data subchannel set hopping or BL data subchannel hopping.

Clause 16. The apparatus of any of clauses 1 to 15, wherein at least one of the FL data or the FL CW is configured to frequency hop between different reception bands configured for the ambient IoT device.

Clause 17. The apparatus of any of clauses 1 to 16, wherein the one or more processors, individually or in combination, are further operable to cause the apparatus to: send an FL query during a discovery stage for the ambient IoT device, the one or more processors, individually or in combination, being operable to cause the apparatus to send the FL data during an FL data transfer stage following the discovery stage within a same frequency range as the FL query.

Clause 18. The apparatus of clause 17, wherein the one or more processors, individually or in combination, are operable to cause the apparatus to send the FL data after a plurality of FL queries respectively for ambient IoT devices in different FL data subchannels during the discovery stage.

Clause 19. The apparatus of clause 17 or 18, wherein the one or more processors, individually or in combination, are operable to cause the apparatus to send the FL data to the ambient IoT device in a FL data subchannel prior to another FL query for a different ambient IoT device in a different FL data subchannel.

Clause 20. An apparatus for wireless communication, comprising: one or more memories; and one or more processors each communicatively coupled with at least one of the one or more memories, the one or more processors, individually or in any combination, operable to cause the apparatus to: obtain backward link (BL) data from an ambient Internet of Things (IoT) device, the BL data configured to frequency hop according to a BL frequency hopping pattern or a forward link (FL) continuous wave (CW) frequency hopping pattern; wherein the BL data is responsive to an FL CW modulated with FL data from a radio frequency (RF) source, the FL CW configured to frequency hop according to a FL data frequency hopping pattern or the FL CW frequency hopping pattern.

Clause 21. The apparatus of clause 20, wherein the one or more processors, individually or in combination, are further operable to cause the apparatus to: obtain, from a base station, a configuration of a BL frequency hopping mode for the ambient IoT device, the base station being the RF source for the FL data and FL CW.

Clause 22. The apparatus of clause 20 or 21, wherein the one or more processors, individually or in combination, are further operable to cause the apparatus to: obtain a configuration for FL data frequency hopping or FL CW frequency hopping in a subchannel, the configuration indicating a subchannel set, a subchannel size, a subchannel number, and a subchannel start frequency or a subchannel end frequency.

Clause 23. The apparatus of any of clauses 20 to 22, wherein the one or more processors, individually or in combination, are further operable to cause the apparatus to: obtain a configuration of an FL data frequency hopping mode or an FL CW frequency hopping mode for the RF source, or of a BL frequency hopping mode for the ambient IoT device.

Clause 24. The apparatus of any of clauses 20 to 23, wherein the one or more processors, individually or in combination, are further operable to cause the apparatus to: obtain, from a base station or a user equipment (UE), a configuration of a BL frequency hopping mode for the ambient IoT device, the apparatus being the RF source for the FL data and FL CW.

Clause 25. The apparatus of any of clauses 20 to 24, wherein the apparatus is an RF reader, and the RF reader is the RF source.

Clause 26. An apparatus for wireless communication, comprising: one or more memories; and one or more processors each communicatively coupled with at least one of the one or more memories, the one or more processors, individually or in any combination, operable to cause the apparatus to: obtain a forward link (FL) continuous wave (CW) modulated with FL data, the FL CW configured to frequency hop according to a FL data frequency hopping pattern or a FL CW frequency hopping pattern; and send backward link (BL) data in response to the FL data using the CW, the BL data configured to frequency hop according to a BL frequency hopping pattern or the FL CW frequency hopping pattern.

Clause 27. The apparatus of clause 26, wherein the one or more processors, individually or in combination, are operable to cause the apparatus to obtain the FL CW according to the FL data frequency hopping pattern and to send the BL data according to the BL frequency hopping pattern, and the one or more processors, individually or in combination, are further operable to cause the apparatus to: obtain a retransmitted FL CW modulated with retransmitted FL data, the retransmitted FL CW being obtained at a different frequency than the FL CW according to the FL data frequency hopping pattern; and send retransmitted BL data using the retransmitted FL CW according to the BL frequency hopping pattern.

Clause 28. The apparatus of clause 26 or 27, wherein the one or more processors, individually or in combination, are operable to cause the apparatus to obtain the FL CW and to send the BL data according to the FL CW frequency hopping pattern, and the one or more processors, individually or in combination, are further operable to cause the apparatus to: obtain a retransmitted FL CW, the retransmitted FL CW being obtained at a different frequency than the FL CW according to the FL CW frequency hopping pattern; and send retransmitted BL data using the retransmitted FL CW according to the CW frequency hopping pattern.

Clause 29. A method of wireless communication performable at a radio frequency (RF) source, comprising: sending a forward link (FL) continuous wave (CW) modulated with FL data, the FL CW frequency hopping according to a FL data frequency hopping pattern or a FL CW frequency hopping pattern; and configuring an ambient Internet of Things (IoT) device to send backward link (BL) data in response to the FL data using the FL CW, the BL data frequency hopping according to a BL frequency hopping pattern or the FL CW frequency hopping pattern.

Clause 30. The method of clause 29, further comprising: sending, to the ambient IoT device, a configuration of a BL frequency hopping mode for the ambient IoT device, the BL frequency hopping mode indicating whether the BL frequency hopping pattern includes BL data subchannel set hopping or BL data subchannel hopping.

1. An apparatus for wireless communication, comprising:
one or more memories; and
one or more processors each communicatively coupled with at least one of the one or more memories, the one or more processors, individually or in any combination, operable to cause the apparatus to:
send a forward link (FL) continuous wave (CW) modulated with FL data, the FL CW configured to frequency hop according to a FL data frequency hopping pattern or a FL CW frequency hopping pattern; and
configure an ambient Internet of Things (IoT) device to send backward link (BL) data in response to the FL data using the FL CW, the BL data configured to frequency hop according to a BL frequency hopping pattern or the FL CW frequency hopping pattern.

2. The apparatus of claim 1, wherein the BL frequency hopping pattern, the FL data frequency hopping pattern, and the FL CW frequency hopping pattern are defined frequency hopping patterns respectively associated with a frequency hopping pattern index.

3. The apparatus of claim 1, wherein the one or more processors, individually or in combination, are operable to cause the apparatus to send the FL data in one of a plurality of FL data subchannels of a FL data subchannel set, and the FL data is configured to frequency hop within the FL data subchannel set according to the FL data frequency hopping pattern.

4. The apparatus of claim 1, wherein at least one of the FL data, the FL CW, or the BL data is configured to frequency hop in response to a trigger event, the trigger event including:
an initial access stage for discovery of ambient IoT devices,
a missed acknowledgment or a negative acknowledgment of the FL data or the BL data,
a configuration of blind retransmissions for the FL data, or
a received power of the FL data or the BL data being below a threshold.

5. The apparatus of claim 1, wherein the one or more processors, individually or in combination, are operable to cause the apparatus to send the FL CW in one of a plurality of FL CW subchannels of a FL CW subchannel set, and the FL CW is configured to frequency hop within the FL CW subchannel set according to the FL CW frequency hopping pattern.

6. The apparatus of claim 1, wherein the FL CW is configured to frequency hop to center frequencies of respective FL data subchannels according to the FL data frequency hopping pattern.

7. The apparatus of claim 1, wherein the FL CW is configured to frequency hop within an FL data subchannel according to the FL CW frequency hopping pattern based on the FL data frequency hopping pattern.

8. The apparatus of claim 1, wherein the FL CW is configured to frequency hop to different FL data subchannels according to the FL CW frequency hopping pattern independently of the FL data frequency hopping pattern.

9. The apparatus of claim 1, wherein the one or more processors, individually or in combination, are operable to cause the apparatus to send the FL data in a FL data subchannel set and to send the FL CW in a FL CW subchannel set, the BL data is configured to be sent in a BL data subchannel set, and the FL data subchannel set, the FL CW subchannel set, and the BL data subchannel set are individually configured subchannel sets.

10. The apparatus of claim 9, wherein the BL data subchannel set is contained within a FL data subchannel of the FL data subchannel set.

11. The apparatus of claim 9, wherein the BL data subchannel set extends outside an FL data subchannel of the FL data subchannel set.

12. The apparatus of claim 1, wherein the BL data is configured to be sent in one or more BL data subchannel sets, the FL CW is configured to frequency hop according to the FL CW frequency hopping pattern, and the one or more BL data subchannel sets are configured to frequency hop at a same frequency shift with respect to the FL CW.

13. The apparatus of claim 1, wherein the BL data is configured to be sent in one or more BL data subchannel sets, and the one or more BL data subchannel sets are configured to frequency hop with respect to the FL CW according to the BL frequency hopping pattern.

14. The apparatus of claim 1, wherein the BL data is configured to be sent in a BL data subchannel, and the BL data is configured to frequency hop with respect to the FL CW to a different BL data subchannel according to the BL frequency hopping pattern.

15. The apparatus of claim 1, wherein the one or more processors, individually or in combination, are further operable to cause the apparatus to:
send, to the ambient IoT device, a configuration of a BL frequency hopping mode for the ambient IoT device, the BL frequency hopping mode indicating whether the BL frequency hopping pattern includes BL data subchannel set hopping or BL data subchannel hopping.

16. The apparatus of claim 1, wherein at least one of the FL data or the FL CW is configured to frequency hop between different reception bands configured for the ambient IoT device.

17. The apparatus of claim 1, wherein the one or more processors, individually or in combination, are further operable to cause the apparatus to:
send an FL query during a discovery stage for the ambient IoT device, the one or more processors, individually or in combination, being operable to cause the apparatus to send the FL data during an FL data transfer stage following the discovery stage within a same frequency range as the FL query.

18. The apparatus of claim 17, wherein the one or more processors, individually or in combination, are operable to cause the apparatus to send the FL data after a plurality of FL queries respectively for ambient IoT devices in different FL data subchannels during the discovery stage.

19. (canceled)

20. An apparatus for wireless communication, comprising:
one or more memories; and
one or more processors each communicatively coupled with at least one of the one or more memories, the one or more processors, individually or in any combination, operable to cause the apparatus to:
obtain backward link (BL) data from an ambient Internet of Things (IoT) device, the BL data configured to frequency hop according to a BL frequency hopping pattern or a forward link (FL) continuous wave (CW) frequency hopping pattern;
wherein the BL data is responsive to an FL CW modulated with FL data from a radio frequency (RF) source, the FL CW configured to frequency hop according to a FL data frequency hopping pattern or the FL CW frequency hopping pattern.

21-25. (canceled)

26. An apparatus for wireless communication, comprising:
one or more memories; and
one or more processors each communicatively coupled with at least one of the one or more memories, the one or more processors, individually or in any combination, operable to cause the apparatus to:
obtain a forward link (FL) continuous wave (CW) modulated with FL data, the FL CW configured to frequency hop according to a FL data frequency hopping pattern or a FL CW frequency hopping pattern; and
send backward link (BL) data in response to the FL data using the CW, the BL data configured to frequency hop according to a BL frequency hopping pattern or the FL CW frequency hopping pattern.

27-30. (canceled)
